(19) United States
(12) Patent Application Publication
(10) Pub. No.: US 2009/0048883 A1
(43) Pub. Date: Feb. 19, 2009

(54) METHOD AND APPARATUS FOR FACILITATING INTRAGOVERNMENTAL TRANSACTIONS

(75) Inventors: Michael D. Kelly, Manassas Park, VA (US); Steffen Frey, Washington, DC (US); Eva Robinson, Waldorf, MD (US); Thomas Nash, Milton (CA); Tracey Renaud, London (GB); Justin Talbot-Stern, Phoenix, AZ (US)

Correspondence Address: Ryan, Mason & Lewis, LLP, 1300 Post Road, Suite 205, Fairfield, CT, 06824, US

(73) Assignee: MasterCard International Incorporated, Purchase, NY (US)

(21) Appl. No.: 12/164,419

(22) Filed: Jun. 30, 2008

Related U.S. Application Data
(60) Provisional application No. 60/958,214, filed on Jul. 3, 2007.

(51) Int. Cl. G06Q 30/00; G06Q 10/00; G06Q 20/00; G06Q 50/00

(52) U.S. Cl. 705/7; 705/30; 705/34; 705/26

(57) ABSTRACT

A plurality of validated electronic trade documents, associated with a transaction between a government agency buyer and a government agency seller, are obtained. The electronic trade documents are logically linked in an intragovernmental transaction container, and periodically scanned to determine if conditions exist for at least partial settlement of the transaction. Responsive to the determination that the conditions for the at least partial settlement of the transaction exist, the at least partial settlement of the transaction is initiated. Capability for handling grants can also be provided.

### CROSS-REFERENCE TO RELATED APPLICATIONS

This patent application claims the benefit of U.S. Provisional Patent Application Ser. No. 60/958,214 of inventors Kelly, Frey, Robinson, Nash, Renaud, and Talbot-Stern, filed Jul. 3, 2007, and entitled “Method and Apparatus for Facilitating Intragovernmental Transactions.” The complete disclosure of the aforementioned Provisional Patent Application Ser. No. 60/958,214 is expressly incorporated herein by reference in its entirety for all purposes.

### FIELD OF THE INVENTION

The present invention relates generally to the electrical, electronic, and computer arts, and, more particularly, to electronic transaction techniques.

### BACKGROUND OF THE INVENTION

While significant progress has been made in the field of automating commercial transactions, the improvement of controls, efficiencies and cost savings within the government's financial management functions has been the topic of recent Office of Management and Budget (OMB) directives. These directives require compliance by the federal government and its agencies. One common problem area is within the financial supply chain (FSC) processes. Government activities purchase goods and services from within their agencies or from other government agencies.

### SUMMARY OF THE INVENTION

Principles of the present invention provide techniques for facilitating intragovernmental transactions. In one aspect, an exemplary method includes the steps of obtaining a plurality of validated electronic trade documents associated with a transaction between a government agency buyer and a government agency seller; logically linking the electronic trade documents in an intragovernmental transaction container; periodically scanning the electronic trade documents in the intragovernmental transaction container to determine if conditions exist for at least partial settlement of the transaction; and, responsive to the determination that the conditions for the at least partial settlement of the transaction exist, initiating the at least partial settlement of the transaction.

In another aspect, an exemplary method includes the step of obtaining at least one electronic grant and at least one electronic payment request associated with a grant from a government agency grantor to a government agency grantee. Also included is logically linking the grant request to the grant based on a grantor-grantee relationship between the grantor and the grantee and a reference number of the grant, and periodically scanning the grant and the logically linked grant request to determine if conditions exist for at least generation of a partial payment record. If it is determined that such conditions exist, the generation of the at least partial payment record is initiated.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

One or more embodiments of the invention can provide substantial beneficial technical effects; for example, one or more of the following:
browser-only, web-based solution which can work with any web browser or operating system (compatibility)
does not require any client installation of software (speed)
no data is stored on the client (increased data security)
no passwords are stored on the client (increased data security)
reporting database is separated from the core processing engine (improved response times)
attachments are on as separate database (improved response times)
solution can interface with ERP or legacy systems (compatibility)
data encrypted at rest (improved data security)

### BRIEF DESCRIPTION OF THE DRAWINGS

FIG. 1 shows an exemplary transaction container, according to an aspect of the invention;

FIG. 2 shows exemplary data flows in connection with the container of FIG. 1;

FIG. 3 shows an exemplary matching process;

FIG. 4 is a flow chart of exemplary method steps, and also serves as a bock diagram of an exemplary system, according to another aspect of the invention;

FIG. 5 is a flow chart of exemplary data transmission, and also serves as a bock diagram, according to yet another aspect of the invention;

FIGS. 6A-6C depict exemplary buyer organization rules;

FIGS. 7A and 7B depict exemplary seller organization rules;

FIG. 8 depicts exemplary trading partnership rules;

FIG. 9 depicts exemplary security features;

FIG. 10 is a conceptual block diagram of an exemplary system, according to a further aspect of the invention;

FIG. 11 provides further details regarding the exemplary container of FIG. 1, including exemplary linkage to other containers;

FIGS. 12-14 depict exemplary aspects of data import and export;

FIG. 15 is an exemplary data flow diagram, according to a still further aspect of the invention;

FIG. 16 is an exemplary block diagram, including data flows, according to an even further aspect of the invention;

FIG. 17 presents a conceptual system architecture, according to an additional aspect of the invention;

FIG. 18 depicts modules that may be included in an exemplary system, having grants management capability, according to another additional aspect of the invention;

FIG. 19 is an exemplary block diagram, with data flows, for a grants module, according to still another additional aspect of the invention;

FIG. 20 is an exemplary status chart for the module of FIG. 19;

FIG. 21 is a flow chart of an exemplary method, according to still another aspect of the invention;

FIGS. 22-24 are partial flow charts of optional exemplary steps that can be carried out, for example, in connection with the method of FIG. 21;

FIG. 25 is a block diagram of an exemplary computer system useful in one or more embodiments of the invention; and

FIG. 26 is a flow chart of an exemplary grants-related method, according to an even further additional aspect of the invention.

### DETAILED DESCRIPTION OF PREFERRED EMBODIMENTS

Initially, note the following definitions used herein:

ACCRUAL is the recognition of revenue when earned or expenses when incurred regardless of when cash is received or disbursed; since cash is typically not received or disbursed in the typical intragovernmental transaction, ACCRUAL in such case is the recognition of revenue when earned or expenses when incurred regardless of when final settlement occurs.
ACCRUAL BASIS OF ACCOUNTING is wherein revenue and expenses are recorded in the period in which they are earned or incurred regardless of whether cash is received or disbursed in that period. This is the accounting basis that generally is required to be used in order to conform to generally accepted accounting principles (GAAP) in preparing financial statements for external users.
RECONCILIATION is the adjusting of the difference between two items (e.g., balances, amounts, statements, or accounts) so that the figures are in agreement. Often the reasons for the differences must be explained. One example would be reconciling a checking account (bringing the checking ledger and bank balance statement into agreement).

### The “IGT” Concept (Intragovernmental Transaction Container)

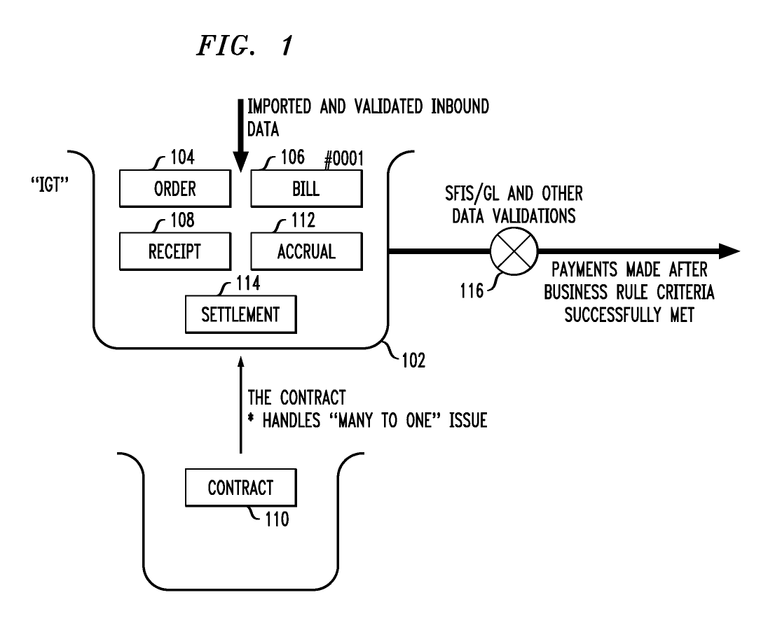

With reference to FIG. 1, in one or more embodiments of the invention, the IGT 102, also referred to herein, and in the aforesaid U.S. Provisional Patent Application Ser. No. 60/958,214, as a “bucket,” is an entity created within an exemplary intragovernmental financial management (IFM) system or service (the latter also referred to in the aforesaid U.S. Provisional Patent Application Ser. No. 60/958,214 as an “intragovernmental commerce exchange (ICE) system,” “government-to-government to be” or “G2G to be” system). It is made up of components (such as, for example, trade documents and other records), or transactions, that are associated with one intragovernmental transaction. An IGT is created when a transaction arrives into the IFM system, passes the pre-validation process, and cannot be added to an existing bucket (because the record's buyer ID and/or order number do not already exist in a bucket). At least one record should typically be in the bucket for it to exist (for example, an order 104, bill 106, receipt 108, or accounting transaction). The first record to create a bucket does not necessarily have to be an order 104. Most often the order 104 will be received first and this will trigger the creation of IGT 102. However, there will be instances where receipts or bills are received prior to the order in the exemplary IFM system. In one or more embodiments, trade documents can exist alone in an IGT (any type) as long as they have a valid reference number to indicate which organization they belong to and a primary document reference number.

The components in the bucket are the unique collection of trade documents combined with settlement and billing records, comments and messages, for example:
Order 104
Receipts 108
Bills 106
Contracts 110
Accruals 112, for example:
   Revenue accruals
   Expense accruals
   Adjustments
Settlement documents 114
Summary Billing File references
Electronic document attachments, Comments, Messages

As will be discussed below, in one or more embodiments, contract 110 provides a link between the disparate components of the bucket, from the imported and validated inbound data, thus the notation “The contract handles ‘many to one’ issue.” Data validation 116 is discussed below. With regard to the figure, please note that “SFIS” is an abbreviation for standard financial information structure and “GL” is an abbreviation for general ledger.

### Intragovernmental Transaction Processing

One or more embodiments of the exemplary IFM system have process transactions through several stages and modules in the system. Import and export data management processing constitutes the pre-processing and post-processing, for example:

Pre-validation/import processing and acceptance

Validation

Matching

Export processing

The IGT processing makes up the “core processing” of:

Seller Acceptance/Decline of an order

Settlement Processing

Summary Billing and Certification

Business rules are established for organizations, trading partnerships and for specific types of transactions. They are preferably quite flexible, so that all users of the system can ensure their settlement processing is done according to their needs. A full description of business rules available in an exemplary IFM system is provided hereinbelow.

### Seller Acceptance/Decline of Orders:

One or more embodiments of the IFM system promote collaboration—especially through order acceptance processing. In this module, which facilitates seller acceptance or decline of orders, sellers can choose to accept or decline orders submitted to them through the IFM system. The system will notify sellers that orders are available for acceptance, and will notify buyers when sellers have accepted or declined their orders.

### Settlement Processing:

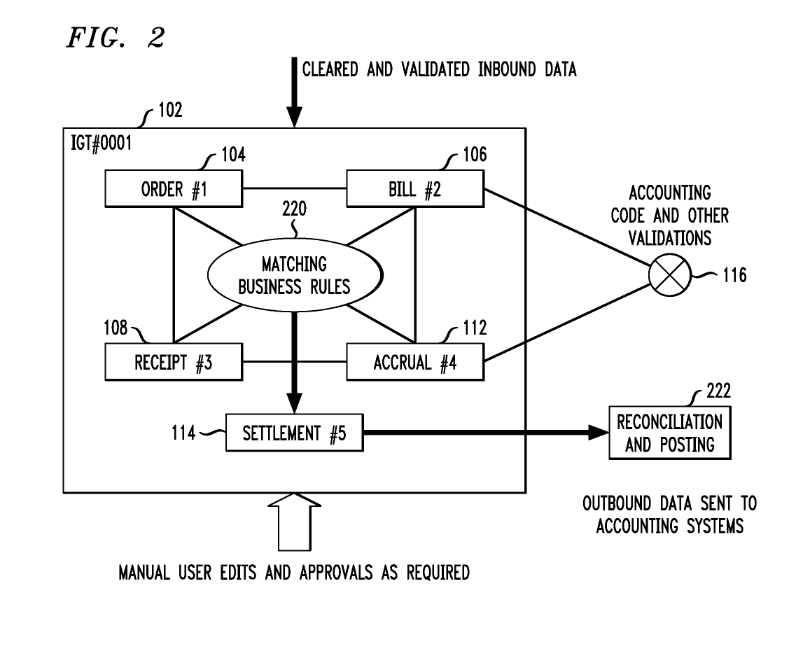

With reference to FIG. 2, once the appropriate business rules 220 are established in the system and validated and completed data is in the IGT 102 and ready to be settled, the IFM system's settlement engine will run automatically in a batch mode on a set schedule and will attempt to execute full settlement on order/bill line item combinations that meet the condition(s) to be settled. If full settlement is unsuccessful or the order has been partially settled, then only the line items that have not been settled will be aggregated and run through settlement. Throughout this specification, similar elements are designated with similar reference characters, and are not described again when appearing in subsequent figures, unless necessary to further explain aspects of the invention.

The settlement rules are invoked and applied to the IGT during the process. The results of the settlement process will determine the status and follow-up actions required on the order 104 and/or bill 106. For example:
Settled: Requires certification or auto-certified and reconciled
Requires Approval: Orders are above the defined threshold for auto-settlement
Out of Tolerance: Order/Bill line item amounts are different by more than the established tolerance and the difference must be resolved by the buyer and seller.

When action is required due to the order and/or bill status, users are notified automatically through email—providing them an easy trigger to the system to manage their transactions.

### Summary Billing and Certification:

This process allows users to verify that all “settled” documents are ready to be posted to the accounting systems, as per block 222, through a certification step. It gives financial managers the ability to validate that the accounts are funded and used appropriately, to reduce errors in posting to the accounting systems. This process can be set up to be manual or automatic.

Reconciled and certified transactions are posted, along with all required accounting transactions, to the customer's accounting systems. The result is a confirmation from the customer accounting system back into the IFM system that updates the transaction to a “posted” status.

### 5-Way Matching:

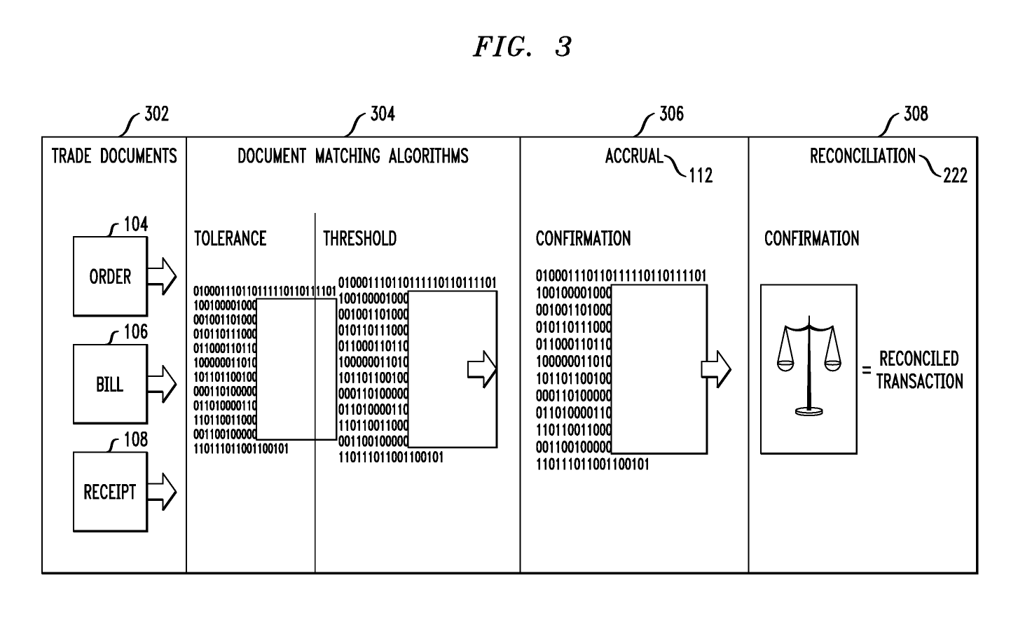

One or more embodiments of the IFM system provide a five-way matching process, an example of which is depicted in FIG. 3. It ties into the IGT concept described above. As per block 302, order 104 has been posted (all line items), receipt 108 is complete (all receipts in IGT 102), and bill 106 has been posted (all bills in IGT 102). After document matching based on criteria such as tolerances and thresholds, in block 304, accrual 112 is generated in block 306, once all accounting transaction(s) are complete (all in IGT 102). In block 308, reconciliation 222 proceeds once settlement document and posting confirmation is complete (all in IGT 102), resulting in a reconciled transaction.

A “closed” IGT (bucket) is one that has all of its components in the status identified above. One or more embodiments of the IFM system allow “partial settlements” which result in an order remaining open (not closed) until all of its line items are posted—at this stage the order and IGT can be closed.

### Data Exchange

One or more embodiments of the IFM system are provided with an all-in-one embedded data exchange module. This module allows for a processor, pre-processor, and even a pre-pre-processor. Business rules are also established in one or more embodiments of the IFM system, by the customer, to govern the import and export processes, so as to ensure that they meet the customer's needs.

In one or more instances, importation goes through three levels of data validation, and data validation is configurable, driven by customer business rules and specific import requirements. The three levels are:

i. Readability: Failed or Received

ii. Pre-validation/Import Acceptance: Rejected or Imported

iii. Validation: Incomplete or Validated, Matched or Unmatched

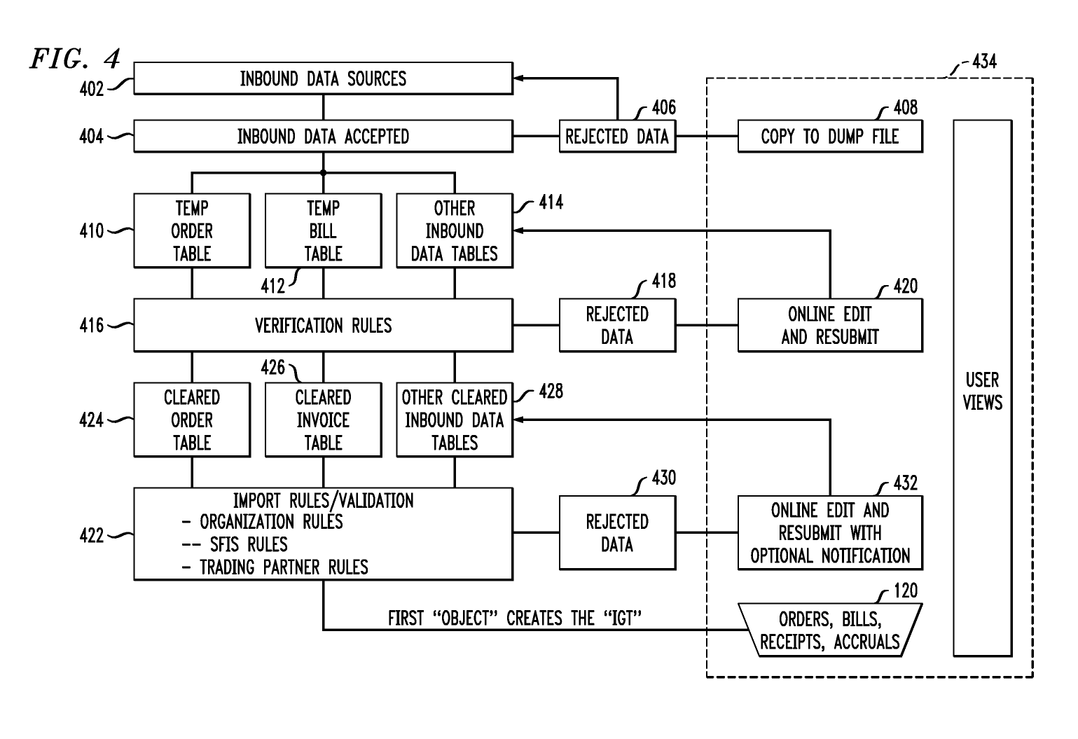

With reference to FIG. 4, orders, bills, receipts (indeed, all import files) can be brought into the IFM system in a three-step acceptance and validation process defined as follows. In a file interface routine step, it is ensured that files (e.g., inbound data sources 402) are readable and can be downloaded into a database file. If the files fail this step, they are considered corrupt. Files that pass this step, as per block 404, move into the import acceptance stage. Files that fail to be received into the system because of corrupt data will be stored in the “dump” table, as per blocks 406 and 408. Data passing through block 404 may be stored, for example, in a temporary order table 410, a temporary bill table 412, or a temporary table for other inbound data, as per block 414. In a document import acceptance step 416, significant data elements are pre-validated. If a document does not pass this step, it is rejected, as per block 418. The IFM system will wait for the errors to be corrected on the file in order to further process it; for example, through the IFM user interface or as a correction submitted electronically, as indicated in block 420. When the document passes this stage, it will move into the validation routine 422. Data that has passed through block 416 and is awaiting validation routine 422 may reside, for example, in a cleared order table 424, cleared invoice table 426, or other inbound cleared data tables 428 Once data has been successfully received into the system, pre-validation of the files is preferred to ensure the following:
Significant fields, such as the Buyer and Seller Identification Number, are populated in a format that matches data in the IFM interface control document.
Buyer ID and Seller ID are valid in the trading partner database. Buyer and Seller ID Number will be matched to the trading partner table to validate their existence within the client department. If one or both of the ID numbers supplied on the incoming data are invalid, then the validation will fail and the record will be rejected.
Status on the existing record.

In the data validation step 422, mandatory fields and business rules driven data elements are validated within each document. Documents that fail validation, in block 430, are incomplete and must be corrected (for example, via online edit and resubmission with optional modifications, as in block 432) in order for them to move into the settlement process. Documents that pass this step are valid and are moved into the next stage of transaction processing within the IFM system. The transaction total equals the total of line item amounts and accounting detail line item amounts within the rounding tolerance. The first valid object creates the IGT 120. Block 434 is indicative of a plurality of user views of the data available to a user of one or more embodiments of the IFM system.

All order, bill and receipt records that are in the IFM system, whether received from external systems or generated and/or created within the IFM system by a user or a system generated process, are preferably validated as follows:

Ensure that mandatory fields are populated
If a required field is missing, reject the record
If an optional field is missing, continue processing
If a required field is incorrectly formatted, reject the record
If an optional field is incorrectly formatted, note the error, blank the value out and continue processing
If a required field is too long, note the error, truncate and continue
If an optional field is too long, note the error, truncate and continue

Ensure that the Account Code sent on the document exists on the validation table.

Ensure that organization relationship is specified in the buyer business rules.

In addition to the data being validated, the transactions are flagged as “matched” or “unmatched,” depending on the existence of other components in the IGT. For example, a bill is imported and validated in the IFM system. However, there is no order that matches to the order identified on the bill. This bill is flagged as “unmatched” and will only be updated to “matched” when the order has been validated in the IFM system.

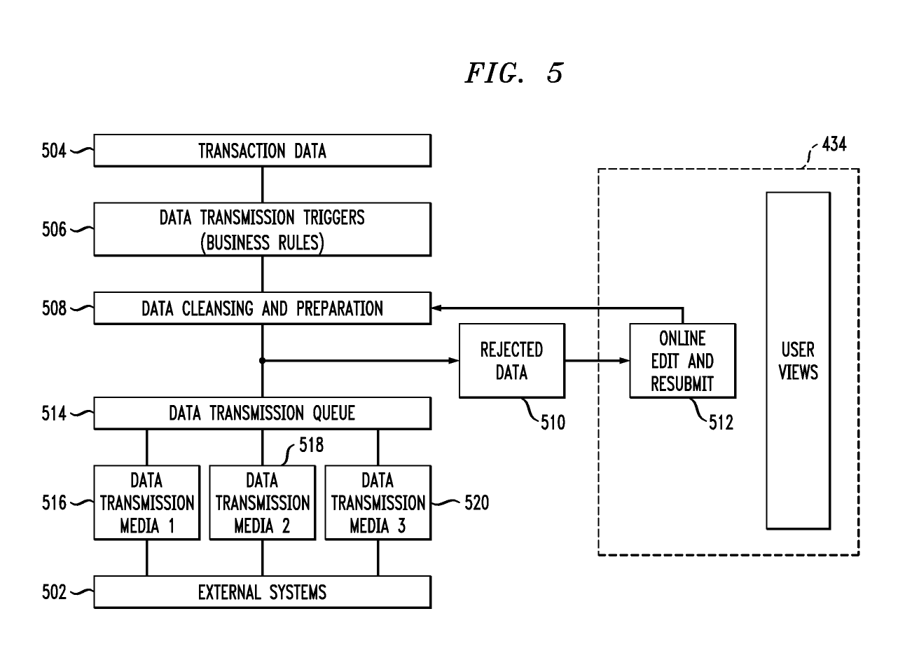

With reference to FIG. 5, embodiments of the IFM system are preferably configured to export data to users or outside (external) systems 502. The following export files and processes are exemplary:
Accounting transactions; this includes accruals, accrual adjustments and liquidations. These will be sent to the buyer and seller accounting systems.
Orders and Bills; so that in the event there are changes, the source systems can receive an updated copy for their records.
Customer billing file; the ability to provide customers of the IFM system a record of their fees for using the IFM system. MasterCard® brand financial services and products are one non-limiting example of financial services networks or other payment networks that can be used with one or more inventive embodiments.

As seen in FIG. 5, transaction data 504 may be transmitted externally based on one or more data transmission triggers (e.g., business rules) 506. A data cleansing and preparation process 508 may be carried out; as per block 510, rejected data may be edited online and resubmitted, in block 512, an example of an additional user view 434. Data that passes cleansing and preparation may be placed in queue 514 for transmission to one or more external systems 502 by one or more data transmission media, such as first, second, and third media 516, 518, 520.

### Edit Settings and User Set Up

One or more embodiments of the IFM system include a combination of maximum configuration capabilities along with ease of setup, providing a series of user types and user roles, which have designated access into the system, in turn providing improved or even optimal control over usage of the system and management of the data. The configurability is designed into the system through a series of business rules.

### Business Rules

Business Rules are established in one or more embodiments of the IFM system for organizations, trading partnerships, and for specific types of transactions. They are preferably quite flexible, so that all users of the system can ensure their settlement processing is performed according to their needs.

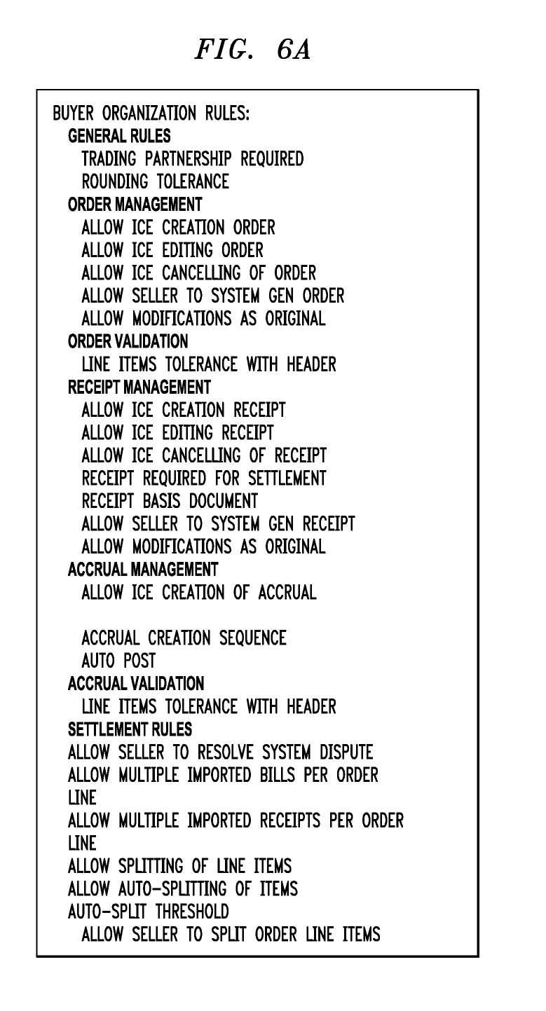

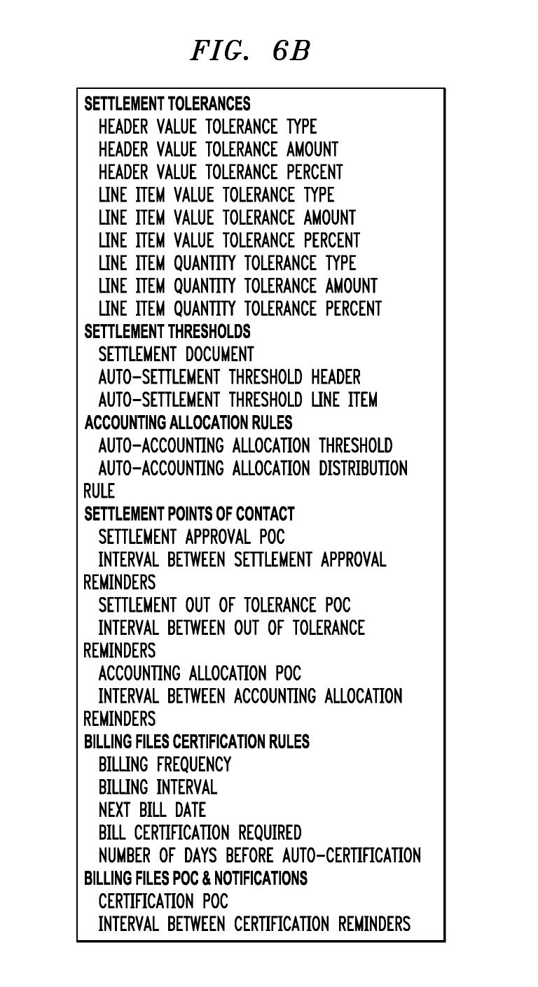

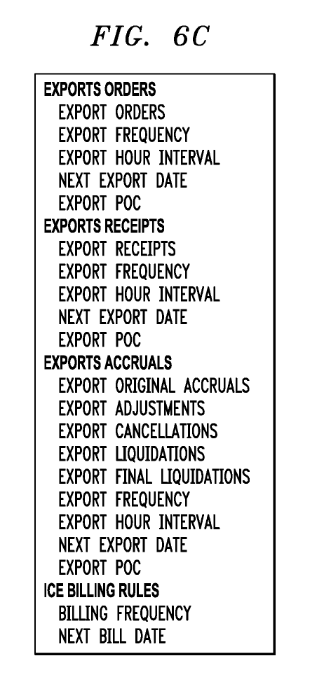

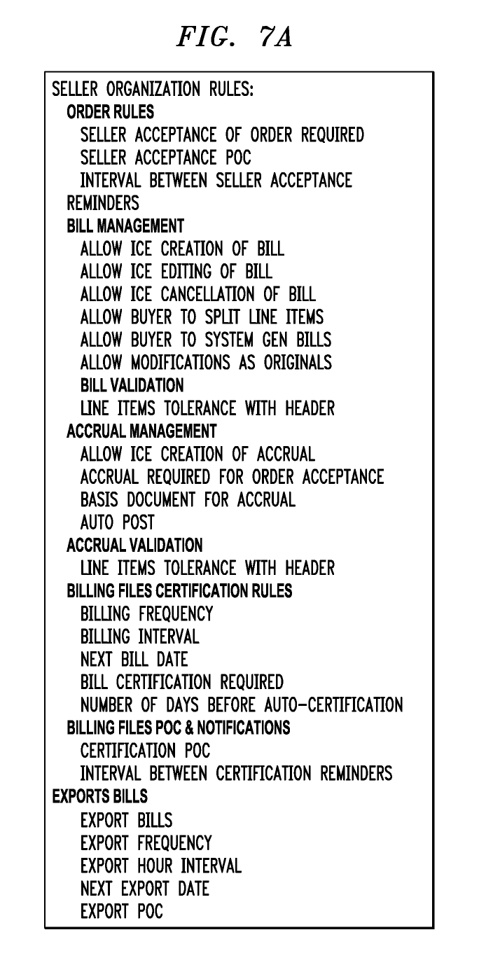

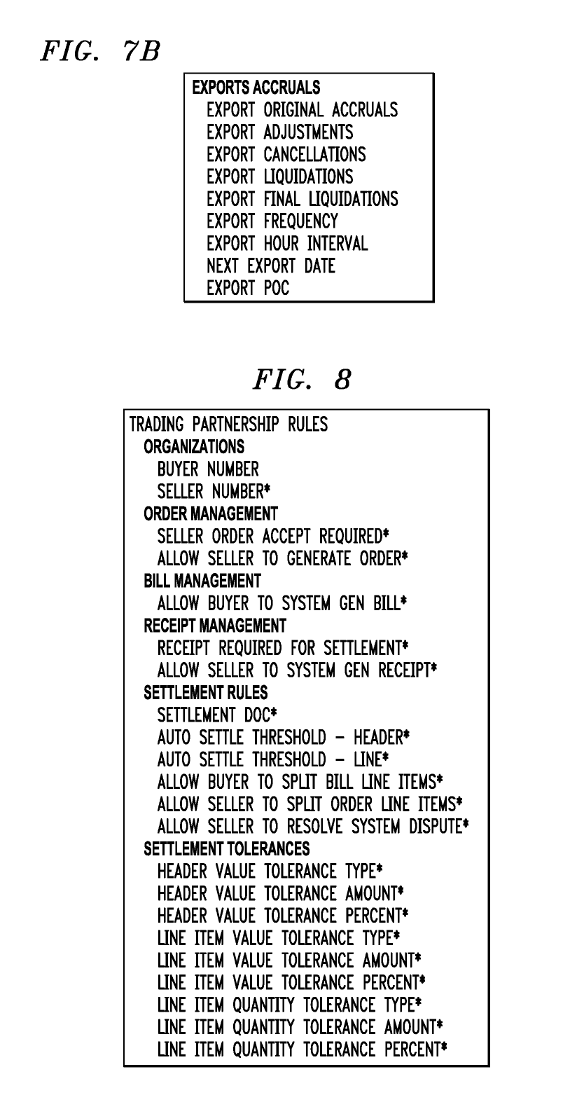

Exemplary business rules available in one or more non-limiting exemplary embodiments of the IFM system are outlined in the tables of FIGS. 6A, 6B, and 6C (exemplary buyer organization rules); FIGS. 7A and 7B (exemplary seller organization rules); and FIG. 8 (exemplary trading partnership rules). Note, “Reqd”=required; “Gen”=generate; “Auto”=automatic; POC=point of contact; DOC=document. Given the teachings herein, the skilled artisan will understand the significance of the business rules in the tables.

### Hierarchical Business Rules

One or more embodiments of the IFM system provide a hierarchical system of business rules, affording significant flexibility. An example of this is provided below for the “Seller Acceptance of Order Required” business rule (which is one of the Seller Organization Rules—see FIG. 7A).

The exemplary four tier seller acceptance of order rule allows sellers to define the specific data element and value that, when found on a particular order, will be the trigger to either require or not require seller acceptance. A seller will still be given the opportunity to accept or not accept all orders—for all buyers or the select trading partners—in one or more embodiments of the IFM system. However, this capability gives sellers an ability to be extremely specific in defining which orders they do and do not want to accept in the IFM system.

The hierarchy of rules, in a non-limiting exemplary embodiment, is as follows:
1. Seller Rules: Global Seller Acceptance Rule (for all orders, for all buyers): (“Global SA”)
   a. Require seller acceptance? yes or no (Y or N)
   b. This rule is required. Therefore a Y or N must be set up for each seller.
2. Seller Rules: Specific Seller Acceptance Rule (for all orders, for all buyers):
   a. Select data field
   b. Define value
   c. Identify if seller acceptance is required (Y) or not required (N) for the defined field/value
   d. This rule is not mandatory.
3. Trading Partner Rules: Global Seller Acceptance Rule (for all orders for the trading partnership selected)
   a. Require seller's acceptance? Y/N
   b. This rule is required. Therefore a Y/N/Organization Default selection must be identified for each trading partnership.
4. Trading Partner Rules: Specific Seller Acceptance Rule (for all orders for the trading partnership selected):
   a. Select data field
   b. Define value
   c. Identify if seller acceptance is required (Y) or not required (N) for the defined field/value
   d. This rule is not mandatory.

An example of the Seller Acceptance “hierarchical” rules is as follows. Seller XX has a trading partner relationship with 3 buyers in the IFM system: Buyer E, Buyer 56 and Buyer JTS. Generally, Seller XX does not want to accept orders in the IFM system. However, there are certain types of orders that he encounters that do need to be formally accepted in the IFM system, and he would like to ensure that these types of orders get reviewed before accepting, to improve his efficiency. In addition to this, one of the buyers, Buyer JTS, has a unique type of order that the others do not, and he wants to ensure that this order type with Buyer JTS always requires his acceptance in the IFM system.

The Seller Acceptance rules for Seller X would be set up as follows:
1. Seller Org Seller Acceptance: N
2. Seller Org Specific Seller Acceptance:
   a. Field: Order Category
   b. Value: SPC
   c. Rule: Y
3. Trading Partner Seller Acceptance Rules:
   a. Buyer E: Organization Default
   b. Buyer 56: Organization Default
   c. Buyer JTS: Organization Default
4. Trading Partner Specific Seller Acceptance Rules:
   a. Buyer JTS:
      i. Field: Order Category
      ii. Value: PAC
      iii. Rule: Y

The outcome of this rule-set is as follows: Seller XX will not accept orders in the IFM system (i.e. the system will auto-accept) EXCEPT in the event that an order (any order assigned to Seller XX with any buyer) has an order category of SPC, or in the event that an order from Buyer JTS has an order category of PAC. Only in these specific instances will Seller XX need to manually accept orders. ALL other orders will have auto-acceptance, including orders from Buyer E and Buyer 56 that have an order category of PAC.

### Organization Management and User Management

Embodiments of the IFM system preferably support customer organizations with many layers, both hierarchical structures and matrix structures. Organizations can be grouped and ungrouped, to ensure that changing needs of organizations can be met. The structure established in the system is flexible without losing any of the past history for data management and reporting. Similarly, one or more embodiments of the IFM system have organization relationships built into the system. The organization relationship has business rules associated with it in order to define the constraints the two organizations must follow.

The setup of users has the same level of flexibility. They can be assigned to one or many organizations and given very distinct roles and privileges within the system, to ensure that all users have the right access to view, manage, and/or report on the organization's data.

Users will have access to manage data (or view data) in one or more organizations (the organization(s) that they work for or are doing data management and/or reporting for). In the event that they are associated with more than one organization, they will be part of a “group” of organizations. Some users are not “active” users (buyers or sellers) but are management personnel or financial managers working for the reporting or financial organization overseeing the activities of the buyer or seller organization. These users do not require an organization created in the system in order to access the data they need to view. These users require simultaneous access to multiple buyer and/or seller organizations in the system for the purposes of viewing a consolidated set of data.

In order for data to be processed into the IFM system, the buyer and seller organizations will be set up in the system. Each authorized organization will have certain characteristics and will be linked to a “master organization” and can be consolidated with other organizations or split up based on the departmental structure.

Organizations added to the IFM system will be validated against the customer's trading partner table. Only authorized system administrators will be able to set up and manage organizations.

Organization relationships may be created for buyer and seller organizations (one of each forms an organization relationship). These represent links between a buyer organization and a corresponding seller organization that do business together. These are created for the purpose of identifying specific business rules to be applied to transactions between these buyer-seller pairs, but are not mandatory in the IFM system, unless identified as required in the buyer organization business rules.

If a buyer organization requires an organization relationship with its sellers in order to settle and accept bills, then the bill will not be settled and/or billed until such time as an organization relationship is created between the buyer and seller. These transactions will be flagged and users will be notified when this situation occurs.

The organization relationships are set up within the organization relationship management area of the IFM system. This is done by identifying the buyer and seller “pair.” Organization relationships are established so that the business rules for the organization relationship will take precedence over the business rules set up for the buyer.

### Reporting Construction

Embodiments of the invention preferably employ embedded SQL 2005 reporting service, and allow for standard, ad-hoc, and/or scheduled reports, with security aligned with application security for data visibility management. The reporting tool is preferably integrated with the IFM application. The following is a list of exemplary features, one or more of which may be included in the reporting tool:
Ad hoc, standard reporting and configurable standard reporting
Scheduled reports (ability to run the report in real time for smaller reports or schedule them to run daily, or run them during less peak performance times to allow the user to perform other IFM system functions while the reports are generated)
Multiple outputs supported including hypertext markup language (HTML), Microsoft Excel® spreadsheet software, comma-separated values (CSV), extensible markup language (XML)
Performance and scalability
Flexibility with designing reports: choice of data to pull and choice of fields and columns to display
Ability to create derived fields based on existing database fields for display on report outputs
Graphical outputs for reports (lower priority than other features); preferably with one or more simple choices for graphs.

There are preferably a number of Government oriented standard reports available in the IFM system.

### Security Architecture

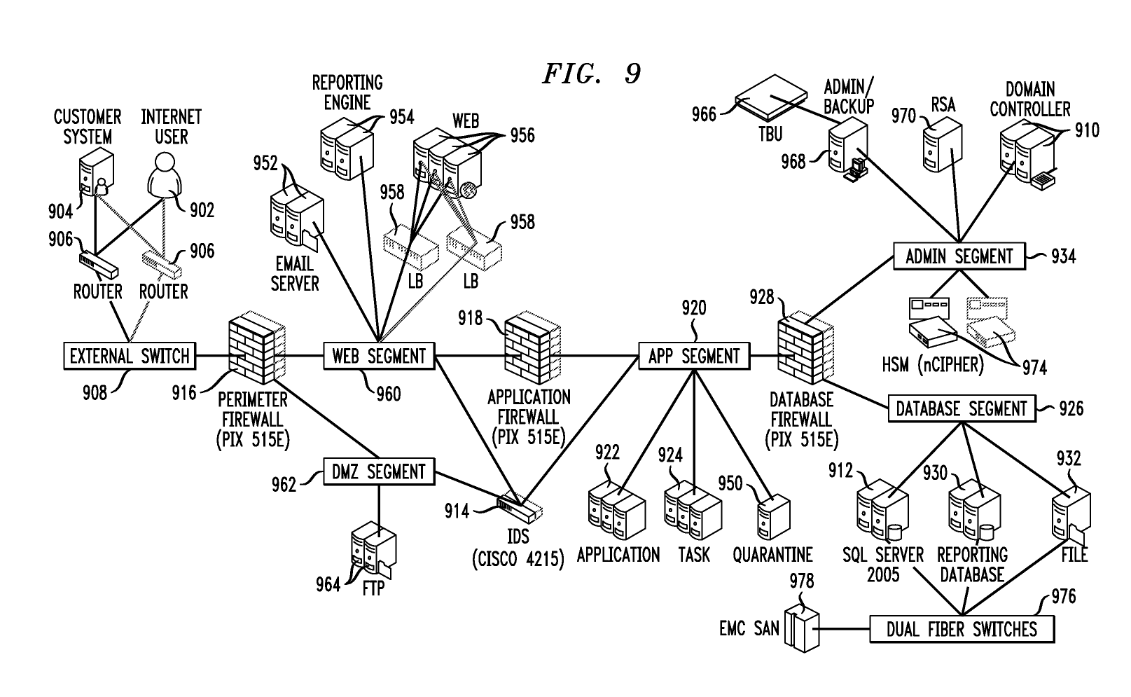

The IFM system preferably includes a multi-layer security architecture (which can be implemented, given the teachings herein, using off-the-shelf (OTS) components. The technical architecture is configured to keep data isolated between buyers and sellers, across organizations, across environments, and includes segregation of the reporting database. With reference to FIG. 9, users or customer systems 902, 904 access the system via one or more routers 906 and external switch 908. In some instances, Windows® 2003 Enterprise server is employed, with back end jobs managed by Windows 2003. Also included are domain controller 910 running Active Directory, SQL Server 2005 (reference 912), Internet Information Server (IIS 6.0), Cisco 515E firewall and Cisco 4215 IDS 914. Sophos Anti-Virus capability may be provided in one or more embodiments.

A first security layer is implemented via SSL encryption and desktop set up. Preferably, 128-bit end-to-end encryption is employed, natively supported by Internet Explorer, with no additional client-side software or hardware required. All access is preferably via Hypertext Transfer Protocol over Secure Socket Layer (HTTPS), with no access via hypertext transfer protocol (HTTP). Preferably, no ActiveX controls, or any downloadable components, are employed, and there is no storage of passwords on the client.

A second layer of security is provided by perimeter firewall 916, such as a Cisco 515E (NIAP certified) firewall, with Cisco 4215 IDS 914 to handle denial of service attacks, IP spoofing, and the like. Preferably, only HTTPS and layer 2 tunneling protocol (L2TP) are employed. Firewall 916 reduces the exposure to the interior firewalls.

A third security layer is provided by application firewall 918, which may be, for example, a dedicated Cisco 515E firewall, to protect the application segment 920 against unauthorized traffic. The application server 922 and task server 924, as well as the backend database segment 926, are protected by firewall 918.

A fourth Security Layer is provided by Database Firewall 928, which may be, for example, a dedicated Cisco 515E firewall to protect the database segment 926 against unauthorized traffic. The database servers 912, 930 and file server 932, as well as the “admin” segment 934, are protected by firewall 928.

A fifth Security Layer is provided by operating system (OS) Authentication & Control Access, which may be managed through dynamic user-groups, and may employ Active Directory object access. In one or more embodiments, additional security is provided by anti-virus functionality; for example, all documents and attachments can be scanned on upload, and infected documents can be rejected, not stored (for example, quarantined within anti-virus software quarantine 950, and not allowed to enter the core databases of the IFM system). Web segment 960 can make use of, for example, e-mail servers 952, reporting engines 954, web servers 956, and load balancing 958. DMZ segment 962 (demarcation zone or perimeter network) makes use of file transfer protocol (FTP) servers 964. Components of database segment 926 can be coupled to storage area network 978 via, for example, dual fiber switches 976. Admin segment 934 may have appropriate tape backup, administrative, RSA security, and hardware security module functionality, as per elements 966, 968, 970, 974.

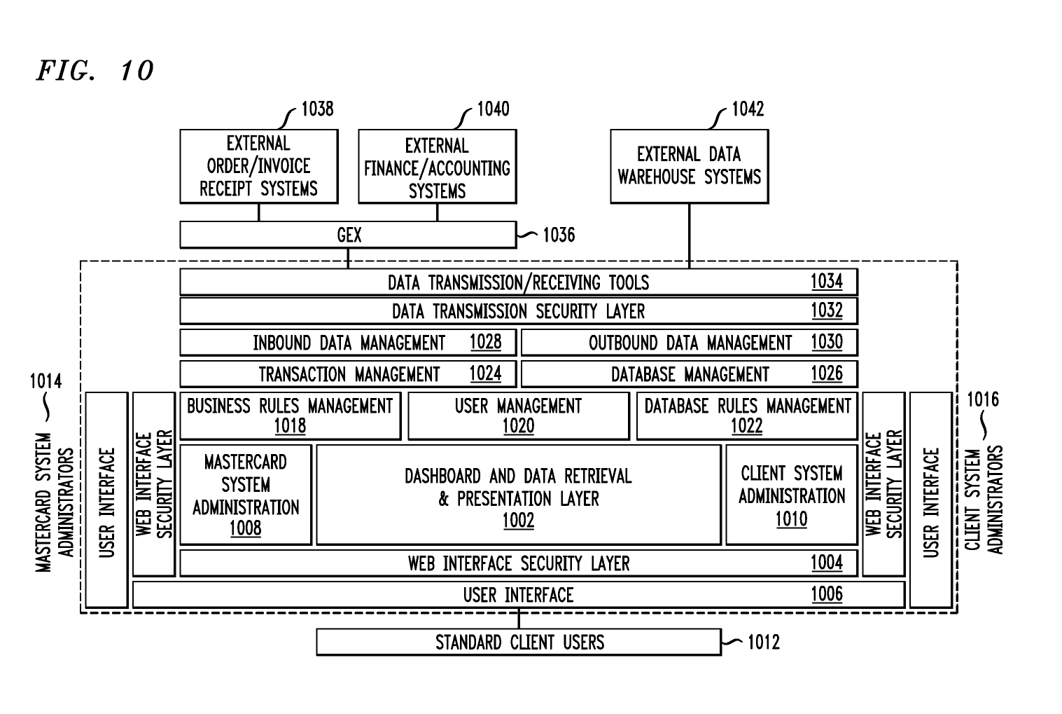

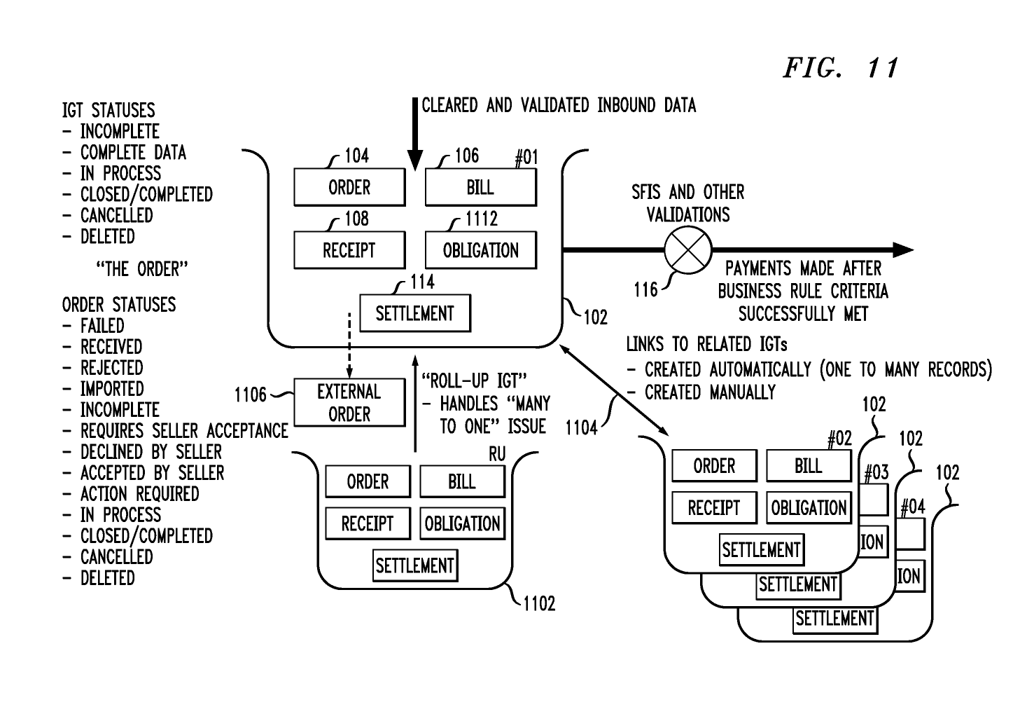

One or more embodiments of the IFM system provide a net-centric solution that enables the reconciliation of any type of intragovernmental transaction. With reference to FIG. 10, one or more embodiments of the IFM system include a user-friendly web interface 1006, which provides rapid data entry and dispute resolution capabilities. The interface 1006 can be accessed by standard client users 1012, client system administrators 1016, and system administrators 1014 of an entity providing the IFM product or service (a non-limiting example of which is MasterCard International Incorporated, Purchase, New York, USA). The user interface 1006 can be separated from one or more blocks or modules by a suitable web interface security layer 1004. Such blocks or modules can include, for example, data retrieval and presentation, block 1002; operator and client system administration 1008, 1010, respectively; and modules for management of business rules, users, and database rules, 1018, 1020, 1022, respectively. The online features also include, embedded in block 1002, robust collaborative communication and documentation tools and a practical reporting tool for all types of users.

In addition to the user interface, the system also includes a flexible and configurable data exchange layer which allows rapid deployment of the solution with disparate systems. This layer may include, for example, data transmission and receiving tools 1034; data transmission security layer 1032; and inbound and outbound data management, 1028 and 1030, respectively. Transaction and database management functionality 1024, 1026, respectively, can also be provided. Embodiments of the IFM system interface easily with supply chain and accounting systems, directly, or alternatively through a translator and router system. In some instances, communication with external order and/or invoice receipt systems 1038 and external finance and/or accounting systems 1040 may be had through the Global Exchange Service (GEX) 1036 of the US government, which provides message broker and mediation services between multiple Department of Defense (DoD) and Federal government agencies as well as commercial industry. Direct communication may also be had with some external systems, for example, a data warehouse 1042.

One or more embodiments of the IFM system can support the import and export of XML or flat file user defined fields (UDFs). Advantageously, embodiments of the system include highly configurable business rules, which allow management of IGTs at a level of precision that is consistent with commercial best practices utilized by operators of payment processing networks (for example, the aforementioned MasterCard International Incorporated), yet provide for the flexibility to roll in complex rule changes over time.

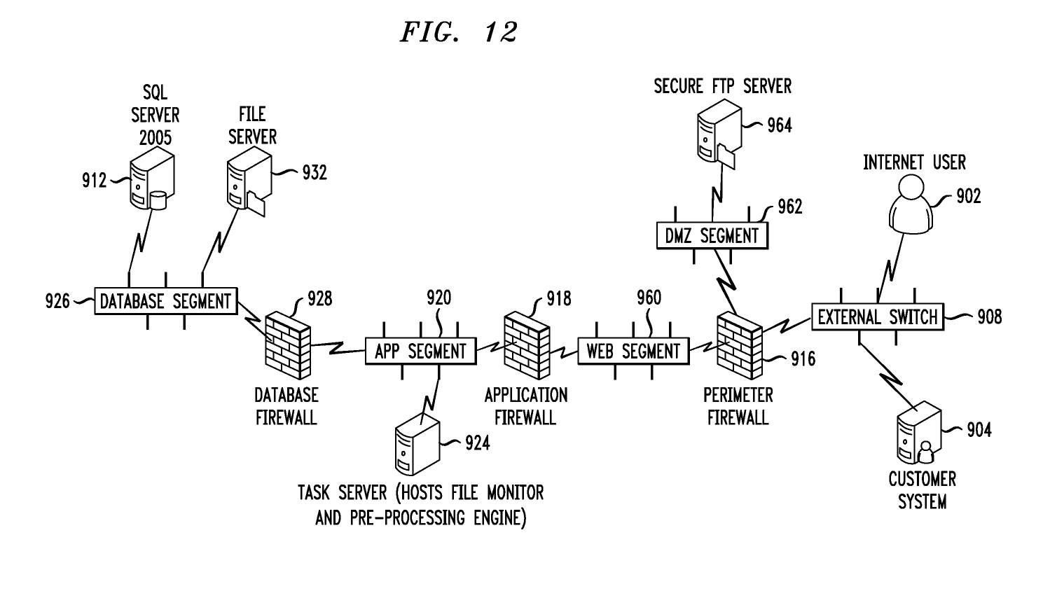

FIG. 11 illustrates the core IGT concept employed in one or more embodiments of the IFM system. Multiple trade documents including order 104, bill 106, receipt 108, obligation 1112, and settlement 114 can be stored and matched within an IGT 102 which provides robust reconciliation capabilities, as well as linkages 1104 available between IGTs 102. Such links may be created automatically or manually. FIG. 11 lists exemplary statuses of IGTs 102 and of orders, as well. Embodiments of the IFM system support complex contract and order/bill combination transactions. The “Roll-up IGT” 1102 is alternative term for the contract 110 of FIG. 1. The skilled artisan will appreciate that the obligation 1112 of FIG. 11 is a more specific case of the accrual 112 of FIG. 1 in the context of governmental transactions. External order 1106 represents a document, such as an order, that has yet to be matched up with the correct IGT.

IFM System Data Storage within the Application

In one or more embodiments, data is stored within several SQL Server 2003 databases. The primary database is referred to as the “Core”. There are additional databases to handle import and export data, archiving, and reporting. The retention of data is governed by system and organizational business rules.

Inbound and outbound files are stored on a file server. Once processed, they are automatically archived for future reference and audit. The retention of files is governed by system and organizational business rules.

In a non-limiting example, the IFM system is implemented in software, which may be created, for example, in languages such as HTML, JavaScript, C#, and/or Visual Basic. Relational database management systems may employ, for example, Microsoft SQL Server 2003. The web site hosting infrastructure may employ, for example, Internet Information Services (IIS) 6.0. It is to be understood throughout that references to particular software packages or languages, or versions thereof, are exemplary and not intended to be limiting.

### Exemplary Hardware Configuration

One or more embodiments of the IFM system use a three-tier architecture, with each tier capable of running on a separate server. IP security (IPSEC) is preferably implemented to ensure that data transfer between the servers is secured. The application can be deployed across multiple physical networks.

The scalable hardware configuration for one or more embodiments of the IFM system allows for additional units to be added, creating new capacity and redundancy. Load balancers are employed to reduce or eliminate the need for any component to be offline while a piece of hardware (hard drive or entire server) is being serviced. In an exemplary embodiment:

1. Perimeter firewall—two single processor servers (redundant PIX firewalls)

2. Internal firewall—two single processor servers

3. Domain controller—two single processor servers

4. Web server farm—includes two dual processor servers

5. SQL Server 2003 cluster—includes two dual processor servers

6. Reporting server—two dual processor servers

7. Admin server—two single processor servers

8. Task server—two dual processor servers

### Exemplary Firewall Descriptions

As discussed above with regard to FIG. 9, in one or more embodiments, the perimeter firewall 916 is a PIX 515E Cisco Firewall. Preferably, the following features are provided:
Robust stateful inspection and application layer security: uses a broad range of advanced firewall services to protect system from the constant barrage of threats on the Internet.
Multi-vector attack protection: incorporates multi-vector attack protection services to further defend from many popular forms of attacks, including denial-of-service (DoS) attacks, fragmented attacks, replay attacks, and malformed packet attacks.
Flexible access control and powerful flow-based policies: custom security policies using flexible access control technologies provided by, for example, the aforementioned Cisco PIX Security Appliances, including network and service object groups, user and group-based policies, with, for example, one hundred or more predefined applications and protocols.

In one or more embodiments, the internal firewall(s) are also PIX 515E Cisco Firewalls, while in other instances, the internal firewalls are ISA 2004 Enterprise edition. Exemplary capabilities include:
Dynamic packet filtering: With dynamic packet filtering, ports open automatically only as required for communications and ports close when the communication ends. This approach minimizes the number of exposed ports, in either direction, and provides a high level of network security. ISA Server supports inbound and outbound IP packet filtering, and allows for blocking fragments, as well as detecting packet-level attacks against the firewall.
Application Filters: A significant level of firewall traffic inspection is application-level security. Good application filters allow one to analyze a data stream for a particular application and provide application-specific processing including inspecting, screening or blocking, redirecting, or modifying the data as it passes through the firewall. This mechanism is used to protect against unsafe simple mail transfer protocol (SMTP) commands or attacks against internal Domain Name Servers (DNS).
Integrated virtual private networking (VPN): This provides standards-based, secure remote access with the integrated VPN services of Windows 2000
Advanced authentication. ISA Server offers a number of authentication mechanisms, including basic, digest, integrated, and certificate-based programs
Inspect secure sockets layer (SSL) traffic: Provide end-to-end security with SSL bridging and inspecting the encrypted SSL traffic.

Policy-based access control. Enforce Internet usage policy by controlling access by user, group, application, destination, schedule, and content type.

### Exemplary User Interface

One or more embodiments of the IFM system provide a simple user interface which facilitates efficient use by frequent users as well as the more occasional user who needs to take action on a transaction. Upon logging on, the first web page the user will see is the dashboard, designed for either the Buyer user or Seller user. Depending on the user's role, he or she will review a Dashboard style suited to review or act on transactions requiring his or her attention. The log-in page can be reconfigured according to certain requirements.

One or more embodiments of the IFM system preferably implement the following principles: define standard processes, rules, and data for intragovernmental ordering and billing between trading partners; support data visibility into IGT data by identifying data objects, entities, and attributes down to the element level; support financial accountability for intragovernmental transactions by enabling the traceability of funds throughout the transaction down to the data element level; enforce capture of trading partner numbers on source business transactions; enhance integrity of reported trading partner balances; and support department-wide savings through operational efficiencies and regulations.

One or more embodiments of the IFM system preferably meet the following fundamental drivers that guide government initiatives: acquisition visibility, common supplier engagement, materiel visibility, and financial visibility. With regard to Acquisition visibility (AV), one or more embodiments of the IFM system record information that provides transparency to acquisition information and includes a lifecycle management of the acquisition to settlement process. Benefits include cost savings in consumables, manpower and support infrastructure. With regard to common supplier engagement (CSE), one or more embodiments of the IFM system maintain trading partner relationships across government agencies, thereby aligning and integrating policies, processes, data, technology and people to simplify and standardize the methods used to interact with government suppliers. Benefits include reliable and accurate delivery of acceptable goods and services, reduced backlogs, and the elimination of redundant program-specific reporting systems.

As far as materiel visibility (MV), one or more embodiments of the IFM system improve the supply chain performance across intragovernmental agencies. Benefits include timely and accurate information on the location, movement, status, and identity of materiel and supplies. In terms of financial visibility (FV), one or more embodiments of the IFM system have the capability to receive, capture, and transmit financial data to provide immediate access to accurate and reliable financial information that will enhance efficient and effective decision-making. Benefits include standardized financial data and reporting processes that enable decision makers to reliably evaluate program options and resource constraints; will also enable greater financial accountability and clean audits.

One or more embodiments of the IFM system, by way of standardized, consolidated, integrated processes, data standards, and business rules, provide significantly enhanced visibility into both the buying and selling elements of intragovernmental transactions, both within agencies and departments, and across the Federal Government. One or more embodiments of the IFM system can assist in ensuring compliance with generally accepted accounting principles (GAAP), which require the elimination of intragovernmental balances from consolidated financial statements to prevent overstating accounts for intra/inter-entity activity. Buyers and sellers can then agree to specific terms that facilitate accurate and timely recording of balanced financial information to ensure that transactions can be eliminated without extensive research and reconciliation efforts.

One or more embodiments of the IFM system may provide one or more of the following benefits: establish a clear path for rapid delivery of enterprise business capability; reduce the burden of reconciling intragovernmental transactions; proactively identify, retire and resolve or mitigate risks and/or issues; provide an opportunity to develop an integrated yet customized solution per agency, thereby creating credible and enduring change management; deliver business capabilities rapidly, at a reduced cost, by identifying similarities across systems along with associated vulnerabilities and providing mitigation solutions; and/or enable agencies to apply common practices that enhance the effectiveness of business-related information systems

One or more embodiments of the IFM system capture the resources and materials required to deliver goods and services based on what is needed, where it is needed, when it is needed, by whom it is needed, and the financial accounting information to ensure all transactions are recorded accurately in a timely manner.

During implementation, user-defined business rules can be established to follow U.S. laws, executive orders, and regulations governing business operations to ensure that all agencies are agreed to the rules, and comply with them. Examples include: auto-settlement within a predefined and agreed upon time limit; exception handling, and notification to end users of disputed or mismatched items. Note that one or more embodiments are directed to transactions within the US government, but techniques set forth herein may be applied to transactions between different levels of government (state and federal, for example), or in jurisdictions outside the US.

One or more embodiments of the IFM system can operate in conjunction with the organization goals, to help bring about: one or more of linkage with the Enterprise Architecture (interfaces can be developed to facilitate data transfer through an import or export process that includes orders, receipts, bills, settlements, disbursements and accruals); net-centricity across the entire organization, via a web-based application; standardization of data, business rules, processes, terms, and capabilities (common terminology, data structures, and user-defined business rules can be established across multiple agencies); application of government and industry standards, as user-defined business rules and application protocols are inherent in one or more embodiments of the IFM system; and a repeatable, structured methodology, as a standard implementation plan and structured training model is available to all agencies.

One or more instances of the invention provide a secure business environment that facilitates and supports cost-effective acquisition of goods and services in support of agency mission performance. Agencies that use instances of the inventive system will typically create a simpler, common, integrated business process for buyers and sellers that promotes transparency and integrity; increase data sharing to enable better business decisions in procurement, logistic, payment and performance assessment; and/or take a unified approach to obtaining modern tools to leverage investment costs for business related processes.

Since some embodiments of the invention are implemented, at least in part, as a web-based application, it is possible to deploy a single point of registration and validation of supplier data accessed by all agencies; implement a central point for consolidated collection and access of statistical and management information related to organization acquisitions; develop a standard glossary and vocabulary to facilitate exchange of data between and within agencies; transform intragovernmental ordering and billing to enable universal electronic processes; reduce payment and collection problems; and enable swift and accurate revenue and expense elimination processes for preparing consolidated financial statements.

One or more embodiments of the IFM system can also import and ensure integrity of SFIS data by storing valid SFIS data, and validating the SFIS data provided through an import process, to support accurate information and/or data requirements for budgeting, financial accounting, cost and/or performance management, and external reporting across the entire enterprise.

One or more instances of the invention provide visibility and reconciliation management of all financial data pertaining to an intragovernmental transaction. The integration between the IFM system and user accounting systems allow the systems to conduct obligation and reimbursement validations, comparisons, and adjustments necessary to ensure that the IGTs will reconcile and balance, with or without user intervention, as specified by the configurable business rules. Moreover, all detailed financial data required to produce the requisite financial statements that comply with government accounting regulations is preferably available for review and audit.

### Exemplary Electronic Data Interchange (EDI) Solution

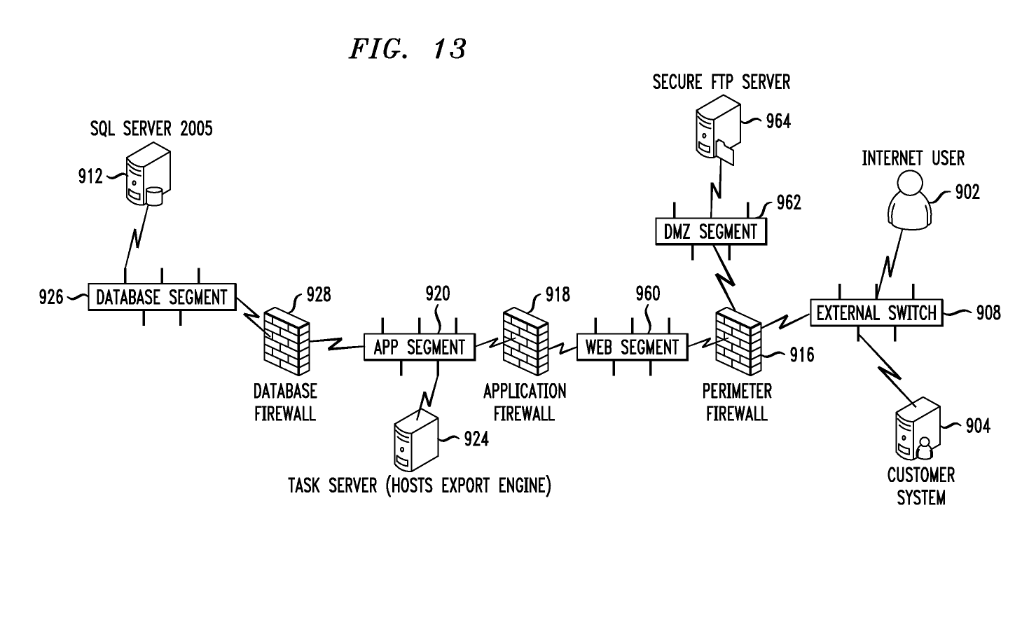

One or more embodiments of the IFM system have the ability to import and export data using a variety of technologies that enable quick and secure interfacing between the IFM system and customer system(s), with concomitant rapid solution implementation. FIG. 12 depicts a file transfer protocol (FTP) import process. A user 902 (or a customer system 904) logs into secured FTP server 964 and uploads data files to a home directory. A file monitoring job, which may run, for example, every minute on task server 924, monitors FTP server 964 for the uploaded files and moves them to the task server 924. For security reasons, it is preferred that no file is left on FTP server 964. A pre-processing engine hosted on task server 924 then parses the data file and stores the data in the database segment 926.

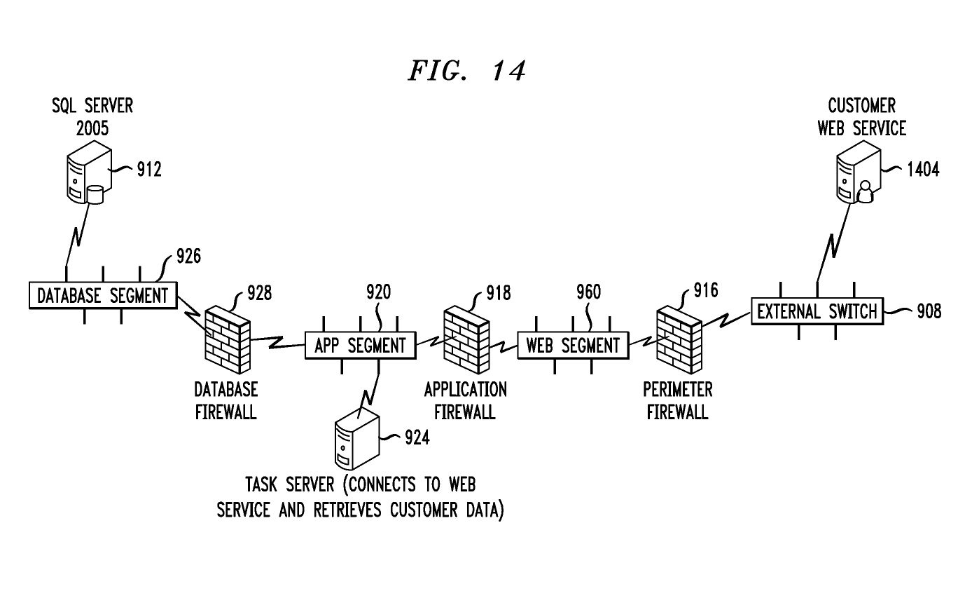

FIG. 13 depicts a file transfer protocol (FTP) export process. In the exemplary embodiment, the IFM system prepares the data to be exported by adding the record into an export queue. An export engine, hosted on server 924, connects to the export database, prepares the export files, and stores them onto secured FTP server 964. Customer 902 (or system 904) then logs onto the secured FTP server 964 and picks up the files.

FIG. 14 depicts a web service approach, wherein a file monitoring job, which runs on task server 924, for example, every minute, connects to the web service 1404. Web service 1404 may be published by the customer. The file monitoring job may retrieve the data in, for example XML format, and store the XML file on the task server 924. A pre-processing engine then parses the XML file and stores the data in the database segment 926.

### Exemplary Data Importation Processes

In one or more embodiments, an import data validation process may address one or more of readability (failed or received); pre-validation (import acceptance—rejected or imported); and validation (incomplete or validated).

Orders, bills, receipts and contracts (in one or more embodiments, all import files) will be brought into the IFM system in a 3-step acceptance and validation process including a file interface routine, document import acceptance, and data validation. The file interface routine step ensures that files are readable and can be downloaded into a database file. Files that pass this step move into the import acceptance stage. The document import acceptance step involves pre-validation of significant data elements. Once data has been successfully received into the system, pre-validation of the files is preferred to ensure that important fields are populated and in the correct format, Buyer ID and Seller ID are valid in the trading partner database, statuses are added to the existing record, and records are not duplicated. When the document passes this stage it will move into the validation routine. During the data validation step, the validation of mandatory and business rules driven data elements within each document is carried out. Documents that pass this step are valid and are moved into the next stage of transaction processing within the IFM system.

All order, bill, contracts and receipt records that are in the IFM system, whether received from external systems or generated and/or created within the IFM system by a user or a system generated process, are preferably validated as follows.

### Exemplary Data Import Routines and Transfer Procedures

In one or more embodiments, the import of data into the IFM system is handled by exporting data from the customer's system and then importing it into the IFM system. Data can be either transferred to the IFM system using a secured FTP server, or the IFM system can retrieve the data from a web service hosted by a customer. In the FTP approach, each organization is given a unique login to connect to the IFM system's secured FTP server. A file monitor engine will scan the FTP server, for example, every 60 seconds, and will move the files onto the task server, which resides within the internal secured network. In the web service approach, the file monitor engine, which runs on the task server and retrieves the data files from the FTP server, is also capable of connecting to web services and retrieving the interface data from customer web services.

A non-limiting exemplary embodiment of the IFM system can process two different file types, flat files (which can be processed through a data exchange pre-processor), and XML. Other embodiments can be configured to handle other types of files as desired. As part of the implementation process, an XML mapping file is created to map the customer field names to the IFM system's field names. This is required, in one or more embodiments, to enable the pre-processing engine to import the data properly into the IFM system.

### Exemplary Data Export

Embodiments of the IFM system are preferably capable of exporting data as Web Services to users or outside systems. In one or more embodiments, there are three web methods which allow the data to be published in XML format:
1. GetOrders: this web method publishes all orders in the system in XML format.
2. GetInvoices: this web method publishes all invoices in the system in XML format.
3. GetReceipts: this web method publishes all receipts in the system in XML format.

For systems unable to support Web Services or XML, one or more embodiments of the IFM system provide flat files to the destination system, for example, directly through FTP or via GEX.

In one or more embodiments, a data exchange layer of the IFM system can include one or more of the following components, as related to data import:
1. A file capture module which checks secure FTP sites, or runs the web services which pull files from target locations.
2. A pre-processor which creates derived fields, and fills others as necessary, based on the source systems' data capabilities.
3. A data mapping process which converts the input EDI, XML or user defined file into a reformatted XML file, which is what the IFM system is “expecting” to receive as a standard input.
4. A data validation processor which identifies missing significant data, flags exceptions, rejects files as required, and if the file passes the initial validation tests, then sees that it is processed through a series of business rules (for example, trading partner validation, organization validation, and the like) prior to being imported into the core IFM database.

For data export, a similar process works in reverse order, whereby extract files are created based on business rules. The data mapping process translates the standard export format into a file format that the destination system is expecting, and then a reverse file capture module either transmits the data to a secure FTP server for pick up or publishes the file to a web service.

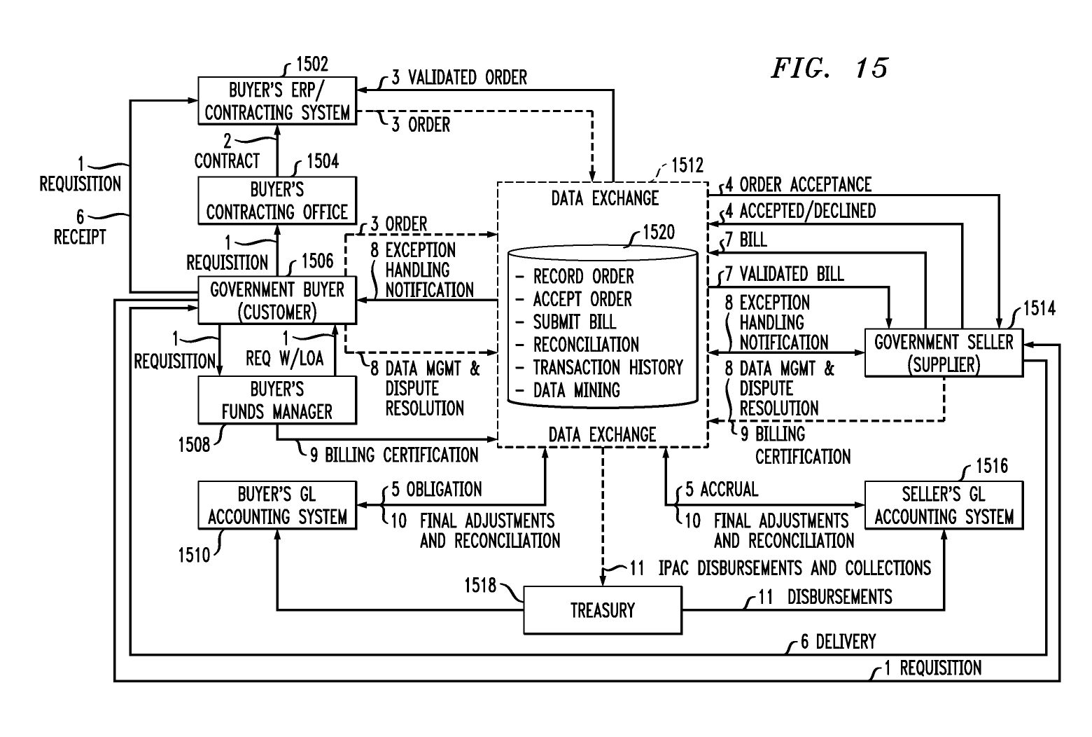

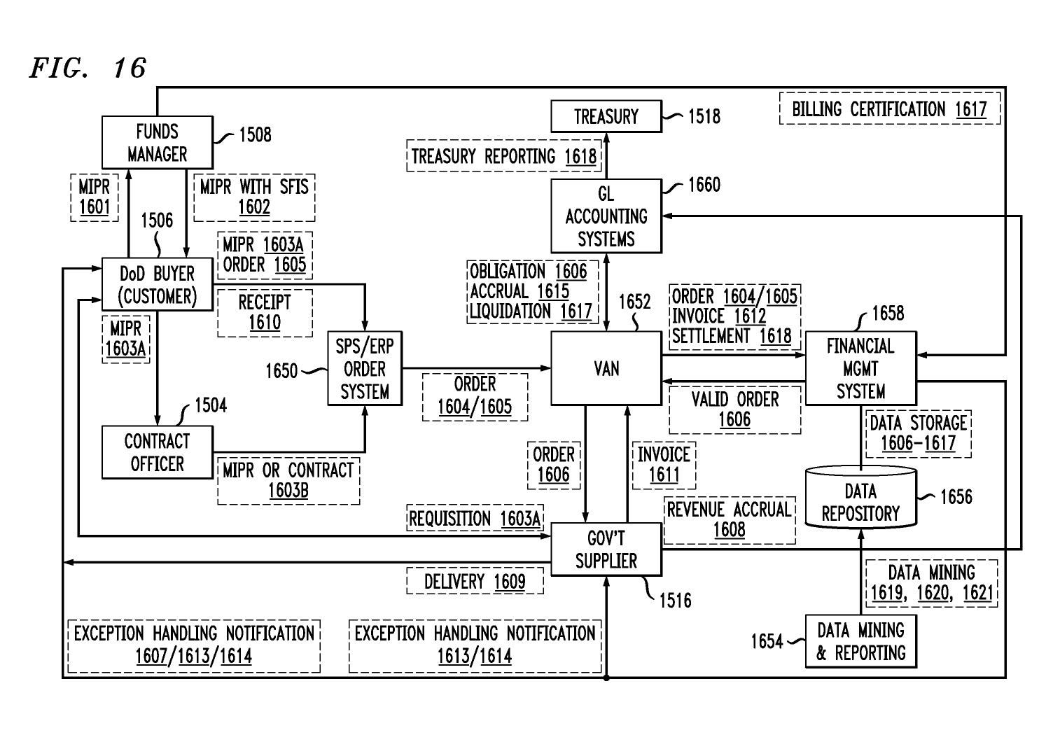

Reference should now be had to FIG. 15, which depicts a detailed process flow diagram, according to an aspect of the invention. In the example of FIG. 15, there are twelve (12) processes; these are designated as reference characters 1-12, and data arrows corresponding to a particular flow are marked with the corresponding reference character.

### Process 1. Requisition and Commitment

The buyer 1506 submits an “Intragovernmental Requisition” to its Funds Manager (FM) 1508 for funds authorization. The FM authorizes funding, and returns the funded requisition to the customer. The requisition may be passed directly to the buyer's enterprise resource planning (ERP)/contracting system 1502, or may be passed through the buyer's contracting office 1504 as discussed below.

### Process 2. Contract

If the buyer is in need of contracting support for a more complex purchase for project work, complex services, or “blanket” purchases, then the buyer 1506 will engage the contracting office 1504 to put a contract or agreement in place. The customer sends the requisition to the Contracting or Acquisition Officer (with expense Account Codes identified) for help in developing the task order, contract or agreement. The Contract Officer develops and completes the task order package which is then sent to the IFM system as a contract (in this context, a contract is a type of order). This is shown by the arrow labeled “2 Contract” between blocks 1504 and 1502 with dotted line labeled “3 Order” between blocks 1502 and 1512.

### Process 3. Order

Once a requisition has been approved and a contract developed (if necessary), the customer 1506 chooses an intragovernmental seller 1514. The customer will generally contact the seller to verify pricing, availability and delivery information on the requisition. This can be done via catalog, phone call, fax or email. The order is then transmitted to the IFM system 1512, or created within the IFM system 1512 by the buyer 1506 (the options are indicated by the arrows from blocks 1506 and 1502 to the IFM system 1512).

### Process 4. Seller Acceptance of Order

The seller's organization business rules will typically be set up to allow sellers to accept orders from buyers within the IFM system. The system 1512 will notify the seller 1514 when an order has gone into “Requires Seller Acceptance” status, at which point a seller can only accept or decline an order. If a seller accepts an order, he is required to provide or confirm his account code and a reference number. The system may also generate an expense accrual for the transaction, which matches the accepted order. The system is able to generate an invoice from the order data upon acceptance of the order. If the seller 1514 declines the order, the status of the order is set to “Declined by Seller” and will be treated like an incomplete order that must be resubmitted to, or corrected within, the system 1512. The user (seller) 1514 is asked (but not required) to provide comments at the time they decline the order.

### Process 5. Obligation and Accrual

If an order is processed by a buyer 1506 in the buyer's source requisition system and transmitted to the IFM system 1512, the obligation will be created after Buyer acknowledgment of the Seller's acceptance of the Buyer's order. If the order has been created within the IFM system 1512, then the obligation will be generated by the IFM system 1512 and transmitted to the Buyer's AP system 1510 after Buyer acknowledgement of the Seller's acceptance, as specified in the Buyer business rules.

All obligations created in the IFM system 1512 are preferably validated using data business rules before transmission to the Buyer's accounting system 1510. One or more embodiments of the IFM system provide the Seller with the option of creating a revenue accrual (or reimbursable) at the time of Seller order acceptance in the IFM system (see arrow between blocks 1512 and 1516); Seller business rules will preferably govern this activity.

As discussed with regard to Process 7 below, when a seller 1514 receives and fulfills an order, the seller will create and transmit a bill to the IFM system 1512. At this time, a (revenue) accrual (or reimbursable) may also be created by the seller system 1516 and may be transmitted to the IFM system 1512, as specified in the seller business rules. If a seller generates the seller's bill within the IFM system 1512, the accrual (or reimbursable) may also be created by the IFM system 1512 and may also be transmitted by the IFM system 1512 to the seller's AR system 1516, as specified by the seller business rules.

Accrual adjustments reflect changes to order and/or invoice amounts that occur between the time the data is sent to the IFM system 1512 and the time the data is settled. Changes to orders and bills made within the buyer and seller source systems will be sent to the IFM system 1512 as corrections. Modifications to orders will flow back through the same seller acceptance/buyer acknowledgement process as did the original order, before any obligation adjustment and seller accrual adjustments are made.

### Process 6. Receiving

After the seller 1514 provides goods or services as required on the order, a receiving report can be processed by the buyer's organization as required by the buyer organization business rules. If a receipt is processed by the buyer it can be transmitted to the IFM system 1512 or created within the IFM system, as required by the buyer organization business rules.

Process 7. Seller Billing through the IFM System

After the seller 1514 provides goods or services as required on the order, a bill can be processed by the seller and transmitted into the IFM system 1512, or generated within the IFM system, as specified in the seller organization business rules. The IFM system preferably performs validation of all invoices. Missing invoices can be created within the IFM system if the record has not come into the system 1512 yet, and the seller organization business rules allow the user to do so. Changes to bills made within the seller's source system are preferably sent to the IFM system as corrections.

### Process 8. Settlement

The IFM system 1512 runs the settlement process using the business rules. If an organization relationship exists between the buyer 1506 and seller 1514, these business rules are consulted first. If not, the buyer and seller business rules will determine the settlement criteria. The business rules allow buyers to define the tolerance they are willing to accept when an invoice amount is not exactly equal to an order amount (dollar value of order or quantity of ordered item(s) and/or service)s)), and the threshold dollar amount above which an order must be manually reviewed prior to settlement.

Orders and bills are matched up and can be automatically settled (if they pass the business rules criteria) or manually settled (if they require manual intervention due to out of tolerance or above threshold conditions). Buyers 1506 are able to edit the order and resubmit through the settlement process, approve the bill amount fully, approve the bill amount partially (i.e. approve part and dispute part of the bill), or dispute the entire bill.

Settlement can be done by line item, so if bills are partially approved, the disputed parts will await further corrections, or approvals at a later stage. Settlement will take place only on the line items of the order and/or bill that have been approved. Those line items that have not been approved will remain open until they have been through the settlement process successfully.

When the system finds an order and/or bill (transaction) that is ready to be settled but does not have referential integrity between the approved order line items and the approved bill line items (between the accounting line items), the system 1512 will notify buyers, such as buyer 1506, that accounting allocation is required. When the user (buyer) opens the order, the system will allow the buyer to navigate to a screen which facilitates the allocation of the approved settlement amounts to the appropriate account codes on each line item.

### Process 9. IFM Certification

At a frequency identified by buyer and seller business rules, consolidated billing files are generated and provided online through a summary and detailed report to provide a view over all “settled” transactions that will be posted to and reconciled within the departmental GL accounting systems 1510, 1516. As required by the buyer and seller business rules, the billing files can be certified by users of the IFM system 1512 (such as, for example, buyers, sellers and their certifying officers—or funds managers). If human certification is not required by the business rules, billing files will be “automatically” certified and sent through to the final adjustment and reconciliation process.

### Process 10. Final Adjustments and Reconciliation

When the certification process is complete, the system will then develop final adjustment and reconciliation records to be posted to the customer's accounting systems (general ledger (GL), accounts payable (AP) & accounts receivable (AR)). The accounting adjustment records detail all changes that have occurred on the orders and bills to line item amounts and account codes. When these accrual adjustments are sent through to the accounting systems, the correct order and bill amount and account code are then reflected in the GL, so that when the final adjustment amounts are sent through for liquidation, reconciliation can occur in the GL. The reconciliation (or “liquidation”) records are also called “final adjustments” that need to be reconciled against the expense and revenue accrual amounts in the GL. The last step in the process is for an acknowledgement to be sent back to the IFM system from the customer accounting systems (if possible). If errors are found when the liquidation data is posted to the customer GL, any discrepancies can be resolved through the detailed billing report, which provides an order and/or invoice level and account code level breakdown of the financial data. The IFM system 1512 will also develop the final order and bill records to be sent back to the source systems if required by the buyer and seller organization business rules.

Process 11. Trading Partner Report (Including Buyer Report. Seller Report, and Exception Report)

One or more embodiments of the IFM system 1512 will link agency transaction information with the pre-established Buyer/Seller relationship in the IFM system to enable the creation of reconciliation reports. In one or more embodiments, the IFM system 1512 will produce three reports: two that show Buyer and Seller information (to be mainly used by the Buyer), and another which is a report on discrepancies. The IFM system 1512 creates this third report, the exception report, by taking the data received from the agency accounting systems and using the Buyer-Seller trading partner tables in the IFM system 1512 to identify any discrepancies between the Buyer and Seller report. A reconciliation report is preferably created to identify any accounting transactions that cannot be eliminated (out-of-balance conditions). This information provides a reconciliation database tool to facilitate the gathering of the data for the elimination process. One or more embodiments do not alter the as-is process for the financial statements elimination.

### Process 12. Data Mining and Reporting

Data mining can be done via the data in the IFM system reporting database, as indicated at 1520. Post-payment compliance reporting and investigation, financial audit reporting, contract compliance reporting, accounting compliance reporting, exception management reporting, operational performance reporting and many other types of reports can be generated through one or more embodiments of the IFM tool.

One or more embodiments preferably include a flexible integration layer, which provides an efficient capability to integrate legacy and migratory systems quickly while minimizing effort. In one or more embodiments, an internet-based reconciliation service with a collaborative workspace for government buyers and sellers ensures that accounting systems are kept in balance throughout the intragovernmental financial supply chain process.

The obligation (discussed with regard to Process 5) is preferably only developed within the solution if required by the customer 1506, and then, the obligation will preferably only be created after buyer acknowledgement of the Seller acceptance of the order. This acknowledgement can be accomplished manually or through business rules. The creation of the obligation adjustment by the IFM system 1512 will typically be based upon the customer's specific accounting policies. The system preferably provides for flexible, configurable rules that allow users to manage their financial data according to the financial policies of their organization.

One or more embodiments of the IFM system 1512 will preferably link the agency transaction information with the pre-established Buyer/Seller relationship in the IFM system, to enable the creation of reconciliation reports. The IFM solution will preferably not alter the as-is process for the financial statements elimination. One or more embodiments of the IFM system leverage several key data elements that will have been captured in the new environment, and these can be used to provide supportable information for the reconciliation process. Instances of the IFM system preferably generate a specified reconciliation report to identify any accounting transactions that cannot be eliminated (out-of-balance conditions). An entity providing the IFM system or service will preferably provide a reconciliation database tool to facilitate the gathering of the data for the elimination process. Instances of the IFM system preferably will then be able to produce a specified reconciliation report that shows all out-of-balance conditions where AP do not equal AR or expenses do not equal revenues. These exception reports can be used to reconcile the out-of-balance conditions and support eliminations. Disbursements are handled by Treasury 1518.

### Additional Information on Exemplary Intragovernmental Transaction Process

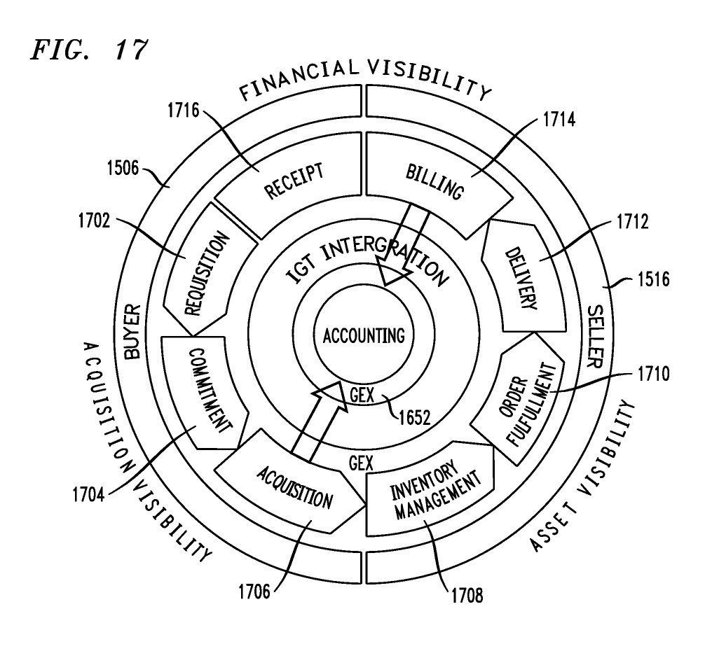

Reference should now be had to FIG. 16, which depicts an exemplary US Department of Defense (DoD) Order, which is a non-limiting example of an order process that can be handled by one or more embodiments of the IFM system. Exemplary steps one through twenty-one will be described. The corresponding data flows are designated in FIG. 16 as 1601 through 1621.

In steps 1-3, an order is created following the procurement process. The order could be created in one of many purchasing systems. If no system exists, the order can be entered manually into, for example, an order entry portal. In step 1, a DoD Buyer (Customer) 1506 submits a Military Interdepartmental Purchase Request (MIPR) or Materiel Request Order (MRO) to its Funds Manager (FM) 1508 for funds authorization. This is frequently done by submitting a paper MIPR to the FM, or can be done electronically by using the FM Commitment and Authorization System. In step 2, the FM 1508 authorizes funding, and returns the MIPR to the Customer 1506. A commitment is established by the FM in his or her commitment and authorization system (if a system is used to generate the MIPR, the authorization of a fund cite will automatically commit the funds against the fund cite). In step 3A, customer 1506 has reviewed the military and commercial catalogs (for products) and has chosen a military (or intragovernmental) supplier. The customer 1506 will generally send a requisition to the supplier 1516 to verify pricing, availability and delivery information on the order. This can be done via phone call, fax, e-mail or other form of written communication. When the seller has verified the information with the customer, the MIPR is completed and sent to the seller. In step 3B, the customer is in need of contracting support for a more complex purchase (project work, complex services, etc.). The customer sends the MIPR to the Contracting or Acquisition Officer 1504 (with lines of accounting (LOA)/SFIS identified) for help in developing a Task Order and/or Purchase Order. The contract officer develops a task order package and helps the customer with contractor selection. The contract officer awards the order by sending a MIPR to the Seller 1516. Use can be made, for example, of order system 1650. Note that SPS refers to Standard Procurement System, which is an optional in one or more embodiments.

In Step 4, if the order is sent electronically, the order is transmitted into the IFM system for pre-validation, for example, via VAN 1652 (note that GEX is a non-limiting example of a value-added network (VAN) that performs data routing). Pre-validation includes matching order totals against record counts. Orders that pass pre-validation are updated (status=passed pre-validation). Notice of acknowledgement is sent to the Buyer point-of-contact (POC). Orders that fail pre-validation are rejected and notice is sent to the Buyer POC. Orders must be corrected and re-sent (i.e., steps 1-3 repeated). Note that functionality of elements 1654, 1656, 1658 was discussed with respect to reference characters 1512 and 1520.

In step 5, manual entry orders and pre-validated electronic orders are validated in the intragovernmental commerce exchange system's validation engine. Validation can take into account one or more business rules, and can include, for example, the following steps:
a. Mandatory fields are populated and in correct format
b. LOA validated against global edit table (GET) or other validation tables
c. Validation of trading partners. Populate POC from Trading Partner Database (“TPD”)

In step 6, orders that pass validation are updated (status=valid order) in the IFM system, stored in the Data Repository 1656), formatted and sent to Seller 1516. Obligations (expense accruals) are sent to source accounting system (formats can include, for example, EDI, XML, UDF) via GEX 1652.

In step 7, orders that fail validation are updated (status=invalid order) in the IFM system, stored (in Data Repository 1656), and a notification is sent to the Buyer POC. Exception handling is typically required to correct and resubmit an order in the IFM system.

In step 8, DoD Seller 1516 receives the order (notification and/or order sent via GEX 1652 from system 1658) and posts it to their accounting system (UDO—Undelivered Order—revenue accrual). In step 9, the DoD Seller 1516 provides goods or services. In step 10, Receipt is processed by a DoD or Non-DoD Buyer. Receipt is transmitted to the IFM system 1658 (via, for example, GEX).

With continued reference to FIG. 16, exemplary DoD billing and/or invoicing will now be discussed. In step 11, Seller 1516 prepares an electronic invoice which is transmitted into the IFM system 1658 (via GEX 1652, for formatting into XML standard), or manually inputs the invoice into WAWF billing entry portal. In step 12, invoices are validated in the validation engine of the system 1658. Business rules, such as the following, may be employed:
a. Mandatory fields are populated and in correct format
b. LOA validated against GET or other validation tables
c. Validate trading partners. Populate POC from Trading Partner Database (“TPD”)
d. DoD Seller Business Partner Network (BPN) and/or invoice number are unique
e. Total of bill detailed lines=bill header total, unit cost multiplied by quantity=total amount on bill
f. Order in status=valid order

Invoices that are missing data elements will be compared to the matching orders and system 1658 will attempt to populate missing data elements in the invoice. In one or more embodiments, appropriate review may be had to determine business rules and/or applicable data elements.

In step 13, invoices that fail validation are updated (status=invalid bill) in system 1658, stored in the Data Repository 1656, and a notification is sent to the Seller POC. Exception handling is required to correct and resubmit the invoice, as per steps 10-13.

In step 14, for invoices that pass validation:
a. The invoices are updated (status=valid bill) in system 1658, matched to the applicable orders in system 1658, and stored in the Data Repository 1656.
b. Invoices are approved by DoD Buyer POC.
c. Exception Handling in system 1658 to resolve errors and disputes. Once errors and disputes are resolved (and invoices amended or resubmitted as required), invoices are approved by DoD Buyer POC.

In step 15, for all invoices that are validated and approved, buyer accounting data (obligation adjustments and accruals) is updated in the Accounts Payable systems and seller accounting data (revenue adjustments and accruals) is updated in the Accounts Receivable systems 1660.

In step 16, bills are generated through the consolidation of approved bills (frequency can vary, for example, from daily to weekly to monthly, depending on best practices established) in system 1658.

In step 17, bills are certified by DoD Certifying Officers (in system 1658) and sent to Data Repository 1656. Liquidations take place in GL accounting systems 1660 (payables and receivables). Because, in one or more embodiments, all liquidations occur after invoices are approved, eliminations are easily performed and reconcilable. Any discrepancies can be resolved through the detailed billing report, which provides an order level and SFIS level breakdown of the financial data.

In step 18, financial reporting (appropriation data) is sent to the Treasury 1518 (for example, via GEX 1652 to the Intra-Governmental Payment and Collection (IPAC) System). In step 19, data mining can be carried out, for example, for reporting and post-payment compliance reporting and investigation, such as one or more of:
Order versus contract
Payment versus order
Accounting issues

In step 20, post-payment compliance exception management is carried out (DoD and Non-DoD Buyer POCs reconcile issues). In step 21, resource management and budget staff access Data Repository 1656 for financial information, financial reporting and audits. Note that every instance of the invention may not have every step, and that not every instance of the invention may perform the steps in the order indicated (this is generally true for all the flow charts and methods discussed herein).

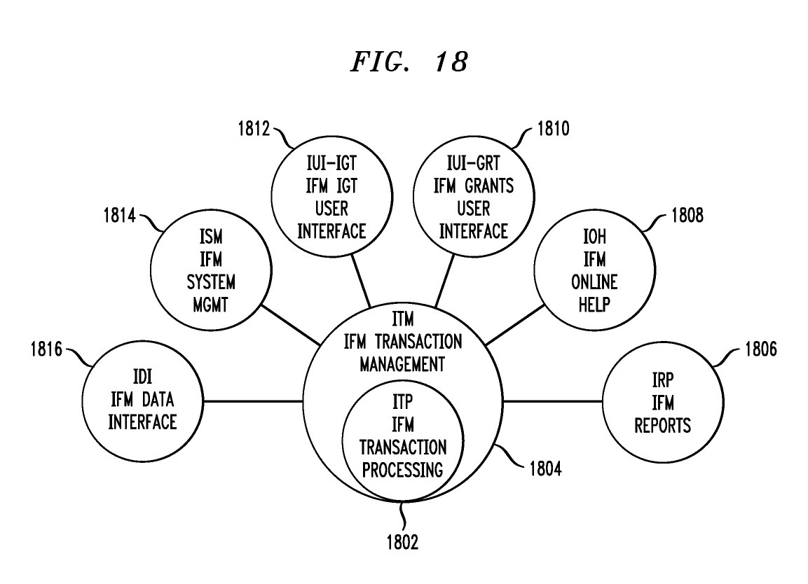

FIG. 17 presents an overview of exemplary processing, according to an aspect of the invention. Buyer 1506 develops an order in an order system or the IFM system, gets funding authorization, and finds seller 1516. Seller 1516 accepts the order and two transactions are generated in the IFM system: one each for buyer and seller GL systems. Seller 1516 fulfills the order, and bills in the IFM system; buyer 1506 receives and inputs the receipt in the IFM system. Reconciliation of the order and bill takes place in the IFM system, with reconciliation of IGTs. A typical cycle is indicated in blocks 1702 through 1716.

Consider a case where a government buyer purchases computer services support from a government seller. A buyer logistics specialist creates the order in an order system or the IFM system, and assigns the GL code, and then identifies the seller in the order system or the IFM system. A buyer funds manager commits funds in a government commitment system and releases the order to the IFM system. The IFM system processes the order and runs validation and/or business rules. A seller computer specialist accepts the order in the IFM system. The IFM system generates a buyer obligation for the government GL accounting system and sends the seller accrual to the government GL accounting system. Assuming a transaction of $165,000, the buyer GL shows −$165,000 and the seller GL shows $165,000 at this point.

A seller computer specialist provides services, and generates a bill for the buyer in the IFM system or an order fulfillment system. The buyer logistics specialist inputs a receiving report in the IFM system or a government work flow system, while the IFM system processes the receiving report. Orders and bills are matched by the IFM system, using the above-discussed 5-way match, and government business rules are invoked by the IFM system. The IFM system generates a settlement file for internal posting and generation of buyer and seller accounting transactions.

Following reconciliation (see block 308 in FIG. 3), the IFM system generates adjustment transactions for buyer and seller, following reconciliation and record confirmation that the adjustment is posted. At this point, the buyer and seller general ledgers are as follows:

| Buyer GL | Seller GL |
|---|---|
| −$165,000 | |
| | +$165,000 |
| +$165,000 | −$165,000 |
| 0 | 0 |

Suppose now that there is a dispute. The seller computer specialist provides services and generates a bill for the buyer in the IFM system or an order fulfillment system. The buyer logistics specialist inputs the receiving report in the IFM system or a government work flow system, and the IFM system processes the receiving report. At this point, the buyer and seller general ledgers are as follows:

| Buyer GL | Seller GL |
|---|---|
| −$165,000 | |
| | +$165,000 |
| | −$10,000 |

The IFM system runs the settlement process (5-way match), and notifies the buyer and seller of the dispute. The buyer and seller resolve the dispute in the IFM system. The buyer logistics specialist approves a bill for $155,000 in the IFM system, while the IFM system generates a settlement file for internal posting and generation of buyer and seller accounting transactions. At this point, the buyer and seller general ledgers are as follows:

| Buyer GL | Seller GL |
|---|---|
| −$165,000 | |
| | +$165,000 |
| | −$10,000 |
| +$10,000 | |

The IFM system generates adjustment transactions for the buyer and seller following reconciliation, and records confirmation that the adjustment is posted. At this point, the buyer and seller general ledgers are as follows:

| Buyer GL | Seller GL |
|---|---|
| −$165,000 | |
| | +$165,000 |
| | −$10,000 |
| +$10,000 | |
| 0 | 0 |

One or more embodiments are preferably configured to meet one or more, and preferably all, of the following governmental requirements (of course, other jurisdictions may have other requirements, which other embodiments of the invention may be configured to meet):

IGT Requirement
Level 1, 2, and 3 source system data
Online Entry for Orders and Bills
Online Error Correction
Validation Engine:

Segmented XML Accounting Data (GL Codes)
Trading Partners (Use Government Designations)

Business Rules
System-Generated Accounting Accruals and Adjustments
Transaction Certification: Auto or Manual
Business Intelligence: Summary, Detailed, Customized
Eliminations controlled and processed in a net-centric application
Collaborative Workspace
Interoperability: Integrates with legacy and migratory systems

One or more embodiments of the invention thus are implemented in a net-centric/web-based form, which leverages existing systems and processes, utilizes common data elements, and is compliant with the Federal Enterprise Architecture (FEA) and internal controls. Further, one or more embodiments may deliver one or more of: interoperability, increased visibility, seamless, automated, reconcilable IGTs, exposure of unexecuted IGTs (enabling re-purposed funding), 5-way document matching, and/or reduced data re-entry and errors.

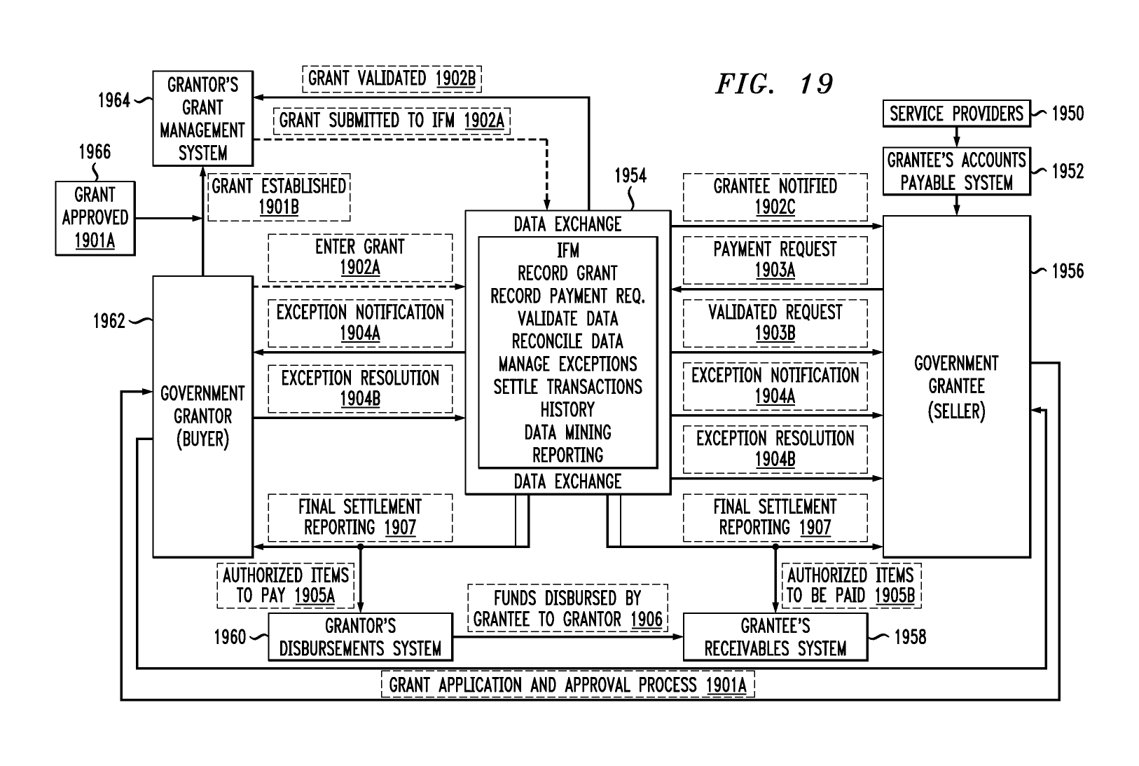

In another aspect, instances of the IFM system may include grants management functionality, for example, as an independent module in the IFM system. Such functionality may include, for example, grant import; payment request import; payment request processing, including automated using business rules, as well as manual; and/or grant settlement, including organizational setup for grantors and/or grantees, as well as business rules setup for grantors. FIG. 18 presents an exemplary block diagram of an embodiment of an IFM system with grants functionality. Included are transaction processing and management modules 1802, 1804, respectively; report module 1806, online help module 1808, system management module 1814, and data interface module 1816. A grants user interface module 1810 is provided, as is IGT user interface module 1812.

In one or more embodiments, during a grants import and acceptance process, a grantor sends award grant data to the IFM system. The putative awardee can accept or decline grants. During a payment request process, the grantee sends payment requests to the IFM system for grant disbursement, and business rules are used to determine payment request status. Grant ad hoc reporting can provide, for example, performance and strategic reports, funds management, and grant analysis and compliance reports. Online help provides information on the system features and functions and provides guidance to users of the ICM grants module for viewing, managing, and reporting in data.

A non-limiting exemplary process flow in the IFM grants module is depicted in FIG. 19. In one or more embodiments, the grants processing in the IFM system will follow the following set of steps. In a first step, designated as 1901, the grantor 1962 and grantee 1956 will go through the normal grant application and approval process 1901A. If the grantor has a grant management system 1964, the grant will be established in the grant system as per 1901B. If the grantor does not have a grant management system, the grant can be processed as per an existing process. All of this activity will preferably be completed before data is entered into and/or submitted to the IFM system 1954. In a second step, designated as 1902, the grantor will provide awarded grants to the IFM system. Grantors will submit the data electronically from their grant management system, as per 1902A, for grant hold/remove hold requests. All grant data will be verified by the IFM system, as per 1902B, to ensure that it meets the pre-established validation rules (refer to discussion of import of grant file below). Note grantee notification 1902C.

In a third step, designated as 1903, the grantee will provide payment requests to the IFM system, as per 1903A. The IFM system will validate that the requests are accurate and conform to the pre-established business rules, as per 1903B. The IFM system will enable grantors and grantees to use the “seller acceptance” process in the IFM grants module, allowing grantees the ability to accept or decline the awarded grants. In a fourth step, designated 1904, the payment request will be processed according to the established business rules for the grantee and grantor, and according to the attributes on the grant and payment request. Payment requests that do not “auto settle” will go into a “hold,” “requires approval,” or “request denied” (action required) status. Notifications will then be sent to both grantor and grantee to identify that action is required to resolve discrepancies between the payment request and the grant attributes, as per 1904A. Exceptions will be resolved manually in the system 1954 by one or both parties, as per 1904B.

Exemplary grants processing will now be described. Grant management can address advance payment eligibility and pooling eligibility. In terms of advance payment eligibility, one or more embodiments of the IFM system recognize two grant “types” as follows:
Grant—not eligible for advance payments
Block—eligible for advance payments to the grantee.

The closing date of the grant, once established, is preferably displayed prominently on the grant in the IFM system.

With regard to pooling eligibility, pooling gives grantees the ability to move money from one grant to another (that is awarded to the same grantee) and also to request one (or more) payments for multiple grants in a single payment request. In one or more embodiments, the IFM system links grants that are eligible for pooling. This can be done through identifying one grant as the “parent” and the other as related (“children”) even if they are all equally important. Another way is to use the IGT (“bucket” concept) to group them together and allow users to view them all at one time on one screen. If the grantee is eligible for pooling of funds, then allow “pooling payment requests” for an amount equal to the total of more than one grant awarded to the same grantee.

With regard to payment request processing, one or more embodiments of the system allow for two types of payment requests, namely, Reimbursement or Advance payment requests. Only Block type grants will typically be allowed to request an advance payment type. Appropriate automatic or manual payment request processing rules may be implemented; for example, business rules can be established so that payment requests must go through a manual review process.

Advance payment requests may be valid under the following circumstances:
Grant Type=Block
Payment Request Type=Advance
Payment Request Amount must be equal to or less than the grant amount outstanding (which may be the entire amount)
Request is made within the 1^{St} quarter of the grant award.

Furthermore, if the payment request is for an advance, and the grant type is eligible for an advance, then the finds will be approved for disbursement if there are sufficient funds left in the grant. If none have yet been disbursed or approved for disbursement, then the entire amount may be approved for disbursement. If some funds have already been disbursed or approved for disbursement, then only the remaining balance will be approved. If the grant is not eligible for advance payment disbursement, it can be put in “Request Denied” status. If the payment request is for an advance, but the grant is not eligible for this type of disbursement, the grant type=grant and the payment request type=advance. In this case, the payment request will be put in “Request Denied” status so that the grantee may revise their request and resubmit (or wait until the end of the first quarter to resubmit). Grantees will be notified of all payment requests in “Request Denied” status.

Reimbursement payment requests may be valid under the following circumstances:
Grant Type=Block, OR
Grant Type=Grant
Payment Request Type=Reimbursement
Payment Request Amount must be equal to or less than the grant amount outstanding
Payment Request made after the 1^{St} quarter in which grant is awarded.

If the payment request is for a reimbursement and made after the end of the 1^{st} quarter in which the grant was approved, the payment request amount will be approved for disbursement if there are sufficient funds left in the grant. If none have yet been disbursed or approved for disbursement, then the entire amount may be approved for disbursement. If some funds have already been disbursed or approved for disbursement, then only an amount equal to or less than the remaining balance will be approved.

In the case of Payment Requests that are put into “On Hold” status by the IFM system:
If payment request is for an amount that exceeds the outstanding grant balance, the payment request will be put in “On Hold” status so that the grantor and grantee may review the request.
Once the closing date has been established, no payment requests will be automatically approved. Each of these payment requests will be automatically set to “On Hold” with the reason code=past the closing date. Grantors with the appropriate authority in the IFM system can manually approve these payment requests.
The system preferably supports both automatic holds (as identified by the payment request process) and manual holds placed by grantor users via the UI.
All requests that are in an “On Hold” status can be manually modified and continue to be held, or alternately can be approved. The IFM system will allow for the removal of holds to be handled manually or automatically through an electronic data feed from the grantor's system.

With regard to manual payment request processing, consider the “Requires Approval” and “On Hold” statuses. If a payment request is for an amount that exceeds the outstanding grant balance, the payment request will be put into hold status so that the grantor may review the request. If the grantor wishes to put the full request or a partial amount of the request “On Hold,” they will be required to enter:
User who placed hold (could be system or via User in user interface (UI))
Date and time of hold
Comments.

Preferably, the grantor can manually approve all of the amount of the request (See discussion above of Amount on Hold). Grantees and grantors will be notified of all payment requests in “Requires Approval” and “On Hold” status.

Aspects of Grants System Administration and Management will now be discussed. With regard to organization structure and information, the Grantor will represent the state or local government that is granting the funds. These organizations should be set up prior to the processing of grant documents. The Grantor organization data required for setup includes, for example:
Organization Name
BPN
   Primary
   Secondary
Address information (primary, billing)
Contact information (for primary and billing)
   Name
   Title
   Phone
   Email
   Fax
Master Organization (Dept) code
Master Organization Identifier (yes/no)

The Grantee will represent the local government, public or private entity that is the beneficiary of the grant awarded. The information required to set up the grantee is as follows:
Entity Name
BPN (one or more of the following):
   tax identification number (TIN)
   Dun & Bradstreet D-U-N-S® number (DUNS)
   Other primary identity and/or entity reference numbers
   Secondary identity and/or entity reference numbers
Address information
Contact information
   Name
   Title
   Phone
   Email
   Fax

With regard to grants business rules, in one or more embodiments, the following business rules apply to grantors. They can be applied at a global grantor level, or at a trading partner level. In one or more embodiments, the grantor can identify which business rules apply to:
All payment requests
All payment requests by grantee
All payment requests by grant type or kind (e.g. Block, Grant)
All payment requests by payment request type (e.g. Advance, Reimbursement, Pooling)
All payment requests that exceed the outstanding balance
All payment requests that have the required reporting status

Grantor Business Rules can include, for example, one or more of the following:
Payment request threshold for automatic payment request processing
Are advance payment requests allowed?
Are block grants allowed?
Is pooling allowed?
First quarter payment restrictions in place?
Allow grantee acceptance?
Require grantee acceptance?
Allow modifications to Grant Data in IFM system?
Allow manual grant data entry in IFM system?
Cancellations allowed on payment requests in system

With regard to grants statuses, each document type (grant, payment request) will have a lifecycle status associated with it at all times. The status reflects the stage which the transaction is in. The transactions can also have “conditions” associated to them, which identify their overall state. In addition, the line items of grant and payment can also have statuses to allow the identification of transactions that go through partial settlement. Buckets (IFM transactions) also have statuses associated with them and are listed below.

As far as transaction status, each transaction type will have a lifecycle status associated with it at all times, which reflects the stage which the transaction is in. The transactions can also have “conditions” associated to them, which identify their overall state.

The following is a list of exemplary valid transaction statuses and conditions:

### Grant Lifecycle Status

Valid lifecycle statuses for grants (headers and line items) are:
1. Imported
2. Rejected
3. Incomplete
4. Awarded (which is the equivalent of “complete”)
5. (canceled)
6. Deleted
7. Acceptance Required
8. Accepted
9. Declined
10. On Hold
11. Closed
12. (canceled)
13. Deleted
   Grant conditions are as follows:
1. Original (as received from grantor system)
2. Modified (user modified in IFM system)

### Grant Status

Valid lifecycle statuses for grant headers are:
1. Imported—grants that have passed the pre-validation process
2. Received—grants that are readable and have not yet been pre-validated.
3. Rejected—grants that do not pass the import acceptance (pre-validation routines checking for significant data, cannot be imported, duplicates) will be in a rejected status.
4. Incomplete—When a grant fails the validation process. An incomplete grant can be assigned to a bucket and matched with other records in the bucket but it will not be settled (or attempt to be settled).
5. Awarded—When a grant passes the validation process successfully.
6. Acceptance required—All grants go through the “requires approval” status. If the rules require approval, then it will be done manually by the grantee. If the rules do not require acceptance, then it will be accepted automatically by the system.
7. Grant Accepted—either manually by grantee or automatic by system.
8. Grant Declined—when the grant goes through the manual acceptance process, this status will occur if the grantee declines the grant.
9. Action Required—when a grant has at least one line item that is in the following status (even if there are line items that qualify the grant to be in any other status), the grant is in “Action Required” status:
   a. On Hold—Grants can be placed on hold pending manual action to remove the hold. In some instances, only manual holds will be placed on grants.
10. In Process—when a grant has at least one line item that is in the following statuses (and none are in the “Action Required” category), the grant is “In Process”:
   a. Received
   b. Rejected
   c. Imported
   d. Incomplete
   e. Grant Acceptance Required
   f. Grant Accepted
   g. Grant Declined
11. Closed—according to the business rules established for the grant, the grant is closed based on a time limit.
12. Cancelled—When a cancellation on a grant has been issued from the source system

### Grant Line Item Status

Grant line items will be given their own independent status. While the grant is “In process,” then the grant line item and the grant may in fact be in the same status (but this is not a requirement). The statuses for grant line items are:
1. Received—grant line items that are readable and have not yet been pre-validated.
2. Rejected—grant line items that do not pass the import acceptance (pre-validation routines checking for significant data, cannot be imported, duplicates) will be in a rejected status.
3. Imported—grant line items that have passed the pre-validation process
4. Incomplete—When a grant line item fails the validation process.
5. Awarded—When a grant line item passes the validation process successfully.
6. Acceptance Required—All grant line items go through the “grant acceptance required” status. Grant line items that were previously “grant accepted” will be automatically set to “grant accepted” again, after running through the “requires grantee acceptance” status in subsequent processing of the line item through the validation process.
7. Grant Accepted—automatic by system.
8. Grant Declined—by the grantee.
9. Closed—according to the business rules established for the grant, the grant is closed based on a time limit.
10. Cancelled—When a cancellation on a grant line item has been issued from the source system.
11. Deleted—by a user with the authority to delete a grant in the IFM system

### Payment Request Lifecycle Status

Valid lifecycle statuses for payment requests are:
1. Imported
2. Rejected
3. Incomplete
4. Validated
5. Requires Approval
6. Request Denied
7. On Hold
8. Dispute
9. Request Approved
10. Suspended
11. Posted
12. Disbursed
13. Spent
14. (canceled)

Payment Request conditions are as follows:
Original or Modified?
   1. Original (as received from grantee)
   2. Modified (user modified in IFM system)
   3. Corrections (modifications made by source system)
On Hold
   1. Pending Document review
Denied
   1. Not eligible for advance
   2. No documents submitted
   3. Past Close Date
Requires Approval
   1. Excess Cash
   2. Over amount limit
   3. Insufficient Documentation

### Payment Request Status

Payment Requests will, in one or more embodiments, be given their own independent status. They are:
1. Rejected—payment requests that do not pass the import acceptance (pre-validation routines checking for significant data, cannot be imported, duplicates) will be in a rejected status.
2. Imported—payment requests that have passed the pre-validation process
3. Incomplete—When a payment request fails the validation process.
4. Validated—When a payment request passes the validation process successfully.
5. Requires Approval—When a payment request requires manual approval because the request amount is over the “threshold” amount specified by the grantor business rules or over the amount available for disbursement on the grant.
6. Dispute—when users (grantors or grantees) review and challenge the discrepancies between grant and payment amount(s).
7. On Hold—Payment requests can be placed on hold pending manual action to remove the hold. This status is generated from the following scenarios:
   i. Payment request is for an amount that exceeds the outstanding grant balance
   ii. Payment request is past the closing date.
8. Request Denied—Payment requests can be denied by manual or automatic techniques. Changes to remove the denied status must be via manual entry. This status is generated from the following scenarios:
   i. Payment request for advance, not block type
   ii. Payment request for full amount in 1^{St} quarter, not block type
9. Request Approved—Requests that have been approved for payment.
10. Posted—the payment request has been settled and moved into the payment process, where the on-line payment has been generated and is awaiting certification by the grantor in grant for payment to be completed (required by grantor business rules).
11. Disbursed—confirmation back from the accounting system that the payment request has posted successfully
12. Spent—confirmation back from the grantee system that the payment request has been expended.
13. Suspended—When a payment request is part of a payment file that has been suspended by the grantor, it is taken off the payment file and its status is set to on hold. These should preferably be corrected and certified.
14. Cancelled—When a cancellation on payment request has been issued from the source system or manually done via the IFM UI. The business rules must be consulted in order to determine at which stage a cancellation is no longer able to be made on a payment request.

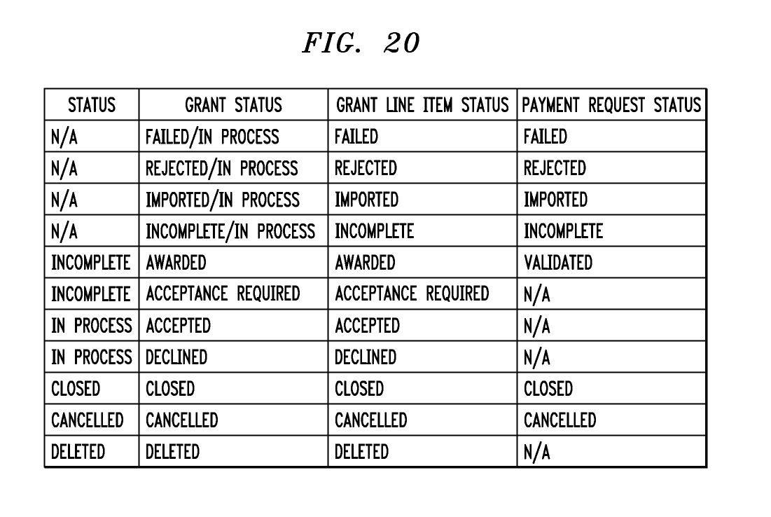

FIG. 20 presents a table summarizing exemplary grant and payment request statuses.

Non-limiting exemplary aspects of data interface module 1816, including import data management, will now be discussed. With regard to the grant file, in a readability step, the IFM system checks the electronic file submission to ensure that the file can be read. If the file fails this test, then it is in a “failed” status and the sending system will receive a notification. If it passes this test, then it can progress to the import acceptance step. In an Import Acceptance step, pre-determined data in the file is checked to ensure that it exists and is in the right format. In one or more embodiments, the mandatory data elements for import acceptance are:
Grantor (in IFM system and valid)
Grantee (in IFM system and valid)
Record type is valid
Record status is valid
Record date is valid

In a validation step, the mandatory data in the file is checked to ensure that it exists, is in the right format, and has valid data in the fields. The fields and requirements are as follows:
Financial amounts on grant are valid and add up to correct amount
Account code sent on grant is valid and in correct format
Grant/grantee relationship is established in the IFM system
Grant Type is provided and valid (=Block or =Grant)

If there are any problems with the data, the grant will be in a status (e.g. “Incomplete”) to identify the fact that the grant will not allow for disbursements until it is corrected and completed its validation.

In one or more embodiments, grants can have modifications made to them, which are submitted by the grantor system to the IFM system. These modifications typically need to go through the same validation process as the original grant, in order for the IFM system to accurately update the grant file. Some of the grant modifications include, but are not limited to, date extensions and supplemental funding. In one or more embodiments, business rules will be established in the IFM system to determine whether grant users can edit and/or correct their documents in the IFM system, or must go back to their source system to do so.

With regard to the Payment Request File, in a readability step, the IFM system will check the electronic file submission to ensure that the file can be read. If the file fails this test, then it is in a “failed” status and the sending system will receive a notification. If it passes this test then it can progress to the import acceptance step. In the Import Acceptance step, pre-determined data in the file is checked to ensure that it exists and is in the right format. In one or more embodiments, the mandatory data elements for import acceptance are:
Grantor (in the IFM system and valid)
Grantee (in the IFM system and valid)
Grant ID (in the IFM system and valid)
Record type is valid
Record status is valid
Record date is valid

In a Validation step, the mandatory data in the file is checked to ensure that it exists, is in the right format, and has valid data in the fields. In one or more embodiments, the fields and requirements are as follows:
Financial amount on Payment Request exists and in correct format
Grant/grantee relationship is established in the IFM system

In one or more embodiments, with regard to modification and/or cancellation of a payment request by grantees, the IFM system will allow the grantee to modify their payment request or cancel their payment request.

By way of summary and provision of further detail, in one or more embodiments of the grants module, the grant is analogous to the order in the transaction case shown in FIG. 1, while the payment requests are analogous to the bills in the transaction case. In lieu of IGT 102, the grant itself serves as an anchoring trade document. As with the transaction case, a series of matching rules and techniques, as well as a data exchange layer for importing documents, can be employed. Since there are typically fewer trade documents in the case of the grants module (as opposed to the transaction case), the matching process may be somewhat simpler. In general, a grants document is received electronically via the data exchange layer. Once the grant is in the system, it is used as the anchor trade document (instead of the IGT). As a payment request comes into the system, look for, first, the associated trading partner (in the grants case, this is, strictly speaking, a Grantor/Grantee relationship rather than a trading partner relationship as in the transaction case). The grantee submits a payment request—within the data submitted, the module first tries to identify which Grantor the request should be associated with. Then, the module looks for another reference number to see which specific grant the request should be associated with. Thus, a payment request is logically associated with the appropriate grant based on the Grantor/Grantee relationship and the appropriate grant reference number.

At this point, just as with an IGT, there are a series of configurable business rules, which perform a continuous comparison to determine, based on status, rules and amounts involved, whether there will be an outcome that may result an action being taken against that transactional data, ultimately resulting in potentially new statuses and perhaps even a settlement or payment record being created. Thus, under appropriate conditions, the payment request turns into a payment within the system (not necessarily the actual movement of funds). In the grant case, the receipt and accrual functions of IGTs may not be required.

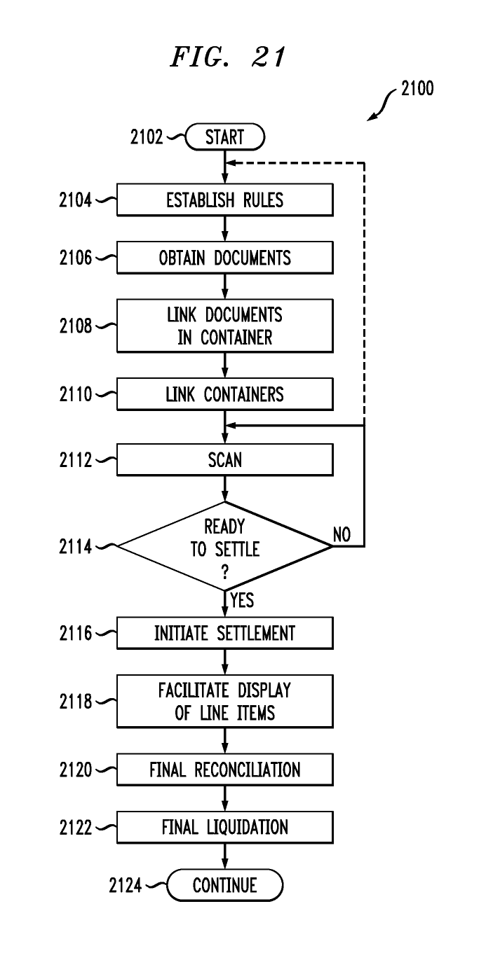

In view of the preceding description of non-limiting exemplary embodiments, and with reference now to flow chart 2100 of FIG. 21, an exemplary method will now be described. After beginning at block 2102, step 2106 includes obtaining a plurality of validated electronic trade documents associated with a transaction between a government agency buyer and a government agency seller. Note that optional steps 2104 and 2110 are discussed below. Step 2108 includes logically linking the electronic trade documents in an intragovernmental transaction container 102 (which may be related, for example, to a contract or a purchase order). In step 2112, the system periodically scans the electronic trade documents in the intragovernmental transaction container to determine, as per block 2114, if conditions exist for at least partial settlement of the transaction. Responsive to the determination that the conditions for the at least partial settlement of the transaction exist, as per the “YES” branch of block 2114, step 2116 includes initiating the at least partial settlement of the transaction. If not ready to settle (NO branch of block 2114), continue periodic scanning per block 2112 (note dotted arrow to block 2104 indicating that other steps, including obtaining additional documents, may also occur in the interim).

In some instances, the obtaining step 2106 includes electronically generating the transaction from systems associated with the government agency buyer and the government agency seller; creation from scratch; and/or creation from another transaction, employed as a template. The trade documents can include, for example, at least one order and at least one additional document associated with the order; by way of a more detailed example, the at least one order, at least one bill, and at least one receipt.

In some instances, the settlement initiated in block 2116 is complete settlement of the transaction. The conditions for settlement may include, for example, posting of the order; posting of the at least one bill (all valid line items of the order being covered by the at least one bill); and completeness of the at least one receipt (all the valid line items of the order being covered by the at least one receipt). Note that in one or more embodiments, there sometimes might be multiple bills and/or receipts in the container 102 for different line items. In some cases, the conditions for settlement include completeness of an accrual associated with the transaction.

Optional step 2118 includes facilitating display of all the valid line items on all the trade documents on a single screen. In one or more embodiments, one might have to scroll down if there were a lot of line items. In one or more embodiments, “on a single screen” means one does not have to jump around to other logical screens, but is inclusive of the case where one might still have to scroll up and down on that single screen. In some instances, everything does fit on a single physical screen display.

Optional steps 2120 and 2122 may be performed, for example, after settlement, and may include, in block 2120, performing a final reconciliation on the transaction, and in block 2122, creating a final liquidation record in an accounting system of the government agency buyer. Although not shown in FIG. 21 for brevity, an additional step can include closing the intragovernmental transaction container 102 after the final reconciliation 2120 is complete. Processing continues at block 2124.

The aforementioned optional step 2104 includes establishing a plurality of government agency seller rules; establishing a plurality of government agency buyer rules; and/or establishing a plurality of trading partnership rules. The electronic trade documents can be validated, at least in part, based on the seller rules, the buyer rules, and the partnership rules. The conditions for the at least partial settlement of the transaction can include, at least in part, compliance with at least some of the seller rules, the buyer rules, and the partnership rules. In some instances, the plurality of government agency seller rules include global government agency seller rules and specific government agency seller rules; the plurality of government agency buyer rules include global government agency buyer rules and specific government agency buyer rules; and the plurality of trading partnership rules include global trading partnership rules and specific trading partnership rules.

With regard to optional step 2110, in some instances, the aforementioned intragovernmental transaction container 102 is a first intragovernmental transaction container, and an additional step includes logically linking the first intragovernmental transaction container to at least a second intragovernmental transaction container (see also element 1104 in FIG. 11, discussed above). The first and second intragovernmental transaction containers (and any additional container(s)) may be related, for example, to a contract.

As noted elsewhere, in some instances, a partial settlement process is carried out when conditions are appropriate (indicated items may be thought of as being “present” but not necessarily “complete”). In some cases, conditions for at least partial settlement include posting of the order; posting of the bill (the bill being for at least one valid line item of the order); and at least one approved bill line item. The at least one line item of the order, bill and receipt should match within a set of business rules. Although omitted from the drawings for brevity, note that in some instances, an additional step includes creating at least one settlement document logically linked to the intragovernmental transaction container 102. Settlement documents can include, for example, a summary billing file reference, and in general terms, these one or more documents identify what is settling, when, and the amount.

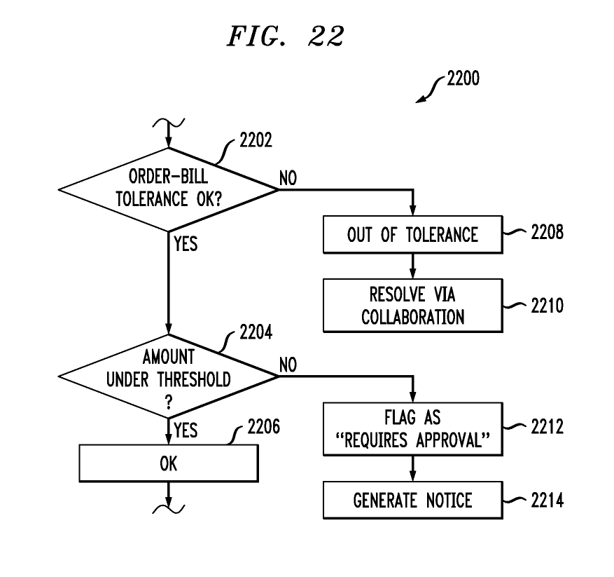

With reference to the partial flow chart 2200 of FIG. 22, in some cases, the aforementioned conditions for at least partial settlement include satisfactory checking of a tolerance between the order and the bill, as at block 2202; and satisfactory checking that the amount of the order is under a threshold, as at block 2204. If the checking in block 2202 yields an out-of-tolerance condition (NO branch), place the bill and the order in an out-of-tolerance status, at 2208; and facilitate resolution of the out-of-tolerance status via collaboration between the government agency buyer and the government agency seller, as per block 2210. If the checking in block 2204 indicates an over-threshold condition (NO branch), place the bill and the order in a “requires approval” status, as per block 2212; and facilitate generation of a notice that manual approval is required by the government agency buyer, as at block 2214. The partial flow chart 2200 can represent, for example, one way of carrying out the check in block 2114—the “OK” block 2206 would, in essence, correspond to the “YES” branch of block 2114, and is reached when both blocks 2202 and 2204 yield a “YES.”

As an aside, note that in some instances, the conditions for at least partial settlement may include certification by the government agency buyer.

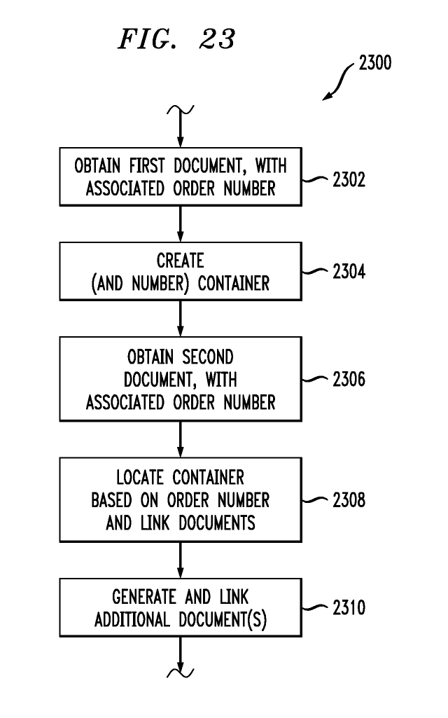

With reference now to partial flow chart 2300 of FIG. 23, in some cases, the order has an order number associated with it, and the logical linking (i.e., between items in a container) is based at least on the order number. Thus, in some cases, the obtaining step 2106 includes a first obtaining sub-step 2302 of obtaining the electronic order, with the associated order number, or the at least one additional electronic trade document associated with the order (the at least one additional electronic trade document also having the order number associated with it). Step 2306 is a second obtaining sub-step of subsequently obtaining the additional document (if the order was first obtained) or the order (if the additional document was first obtained). Logical linking step 2108 can include, subsequent to the first obtaining sub-step 2302, creating the intragovernmental transaction container, as per block 2304; and subsequent to the second obtaining sub-step 2306, at block 2308, locating the intragovernmental transaction container based on the order number, and linking the at least one additional electronic trade document to the electronic order.

In some cases, an additional step can include providing the intragovernmental transaction container with a unique system-generated number, as indicated by the parenthetical in block 2304. As per block 2310, additional steps can include generating at least one additional electronic trade document associated with the order; and logically linking the at least one additional electronic trade document with the trade documents within the intragovernmental transaction container 102. In some cases, the at least one additional electronic trade document is generated in response to the determination that the conditions for the at least partial settlement of the transaction exist.

As an aside, note that in some cases, the trade documents further include an advance shipping notice.

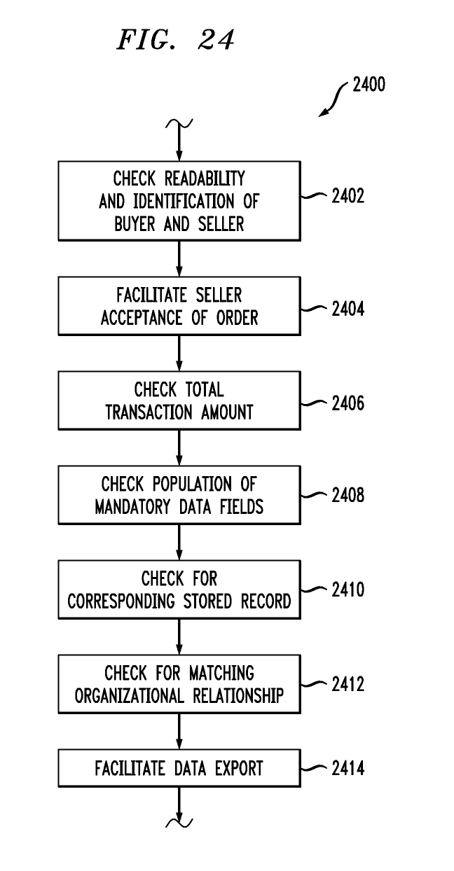

With reference now to partial flow chart 2400 of FIG. 24, in some cases, obtaining step 2106 includes checking the electronic documents for readability and checking the electronic documents for correct identification of the government agency buyer and the government agency seller, as per block 2402, as well as facilitating indication of acceptance of the order by the government agency seller, as at block 2404. In some instances, the electronic documents comprise at least one order and at least one receipt, and an additional step includes performing a detailed data validation on the at least one order and/or the at least one receipt. In a non-limiting example, the detailed data validation includes checking that a total transaction amount equals a sum of line item amounts, within a rounding tolerance, as at block 2406; checking for population of mandatory data fields, as per block 2408; checking for existence of a stored record corresponding to an account code in the at least one order and/or the at least one receipt, as per block 2410; and checking for a matching organizational relationship in business rules of the government agency buyer, as per block 2412. In some instances, block 2410 can be a subset of looking at the general ledger, with codes therein, to see what accounts can be used. With regard to block 2412, in one or more instances, there might be a field in the incoming document that specifies the putative organizational relationship. In some instances, the detailed data validation is further performed on general ledger data and/or line of accounting data. Furthermore, validation can be based, for example, on both system default criteria and a government-agency-buyer-generated custom validation-table.

In another aspect, shown in block 2414 of FIG. 24, an additional step can include facilitating export of at least one of an accounting transaction, an updated order, an updated bill, and a billing record to at least one of a data processing system of the government agency buyer and a data processing system of the government agency seller.

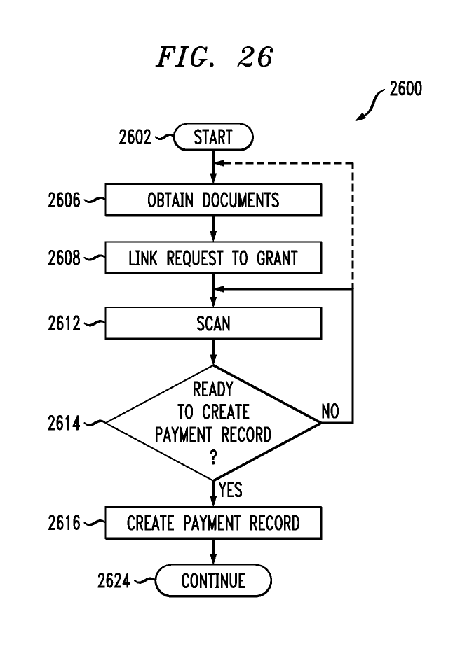

With reference to FIG. 26, in the grants context, an exemplary method 2600, after beginning at block 2602, includes the step 2606 of obtaining at least one electronic grant and at least one electronic payment request associated with a grant from a government agency grantor to a government agency grantee. Also included are step 2608, logically linking the grant request to the grant based on a grantor-grantee relationship between the grantor and the grantee and a reference number of the grant; and step 2612, periodically scanning the grant and the logically linked grant request to determine if conditions exist for generation of at least a partial payment record. If it is determined that such conditions exist, as per the yes branch of block 2614, step 2616 includes initiating generation of the at least partial payment record. Processing continues at block 2624. It will be appreciated that FIG. 26 is analogous to FIG. 21 for the transaction process, with analogous steps receiving the same reference character incremented by five hundred. Other potential steps are omitted for clarity, but it will be appreciated that establishment of rules, display of data, linkage between grants, and so on, could all be included as appropriate for grants functionality, in a manner similar to the corresponding functionality described for FIG. 21.

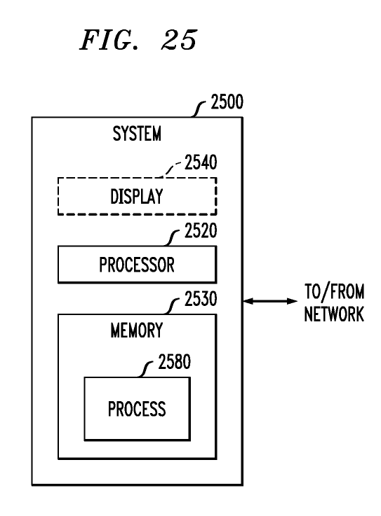

The invention can employ hardware and/or software aspects. Software includes but is not limited to firmware, resident software, microcode, etc. FIG. 25 is a block diagram of a system 2500 that can implement part or all of one or more aspects or processes of the present invention (for example, engine 502 and associated databases and data warehouse(s) and registries). As shown in FIG. 25, memory 2530 configures the processor 2520 to implement one or more aspects of the methods, steps, and functions disclosed herein (collectively, shown as process 2580 in FIG. 25). The memory 2530 could be distributed or local and the processor 2520 could be distributed or singular. The memory 2530 could be implemented as an electrical, magnetic or optical memory, or any combination of these or other types of storage devices. It should be noted that if distributed processors are employed, each distributed processor that makes up processor 2520 generally contains its own addressable memory space. It should also be noted that some or all of computer system 2500 can be incorporated into an application-specific or general-use integrated circuit. For example, one or more method steps could be implemented in hardware in an ASIC rather than using firmware. Display 2540 is representative of a variety of possible input/output devices.

### System and Article of Manufacture Details

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention can make use of computer technology with appropriate instructions to implement method steps described herein. Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention. For example, specific servers, security provisions, and so on are exemplary and non-limiting in nature, and exemplary rules or provisions listed as “required” or “mandatory” may be optional in other instances.

What is claimed is:

1. A method comprising the steps of:
obtaining a plurality of validated electronic trade documents associated with a transaction between a government agency buyer and a government agency seller;
logically linking said electronic trade documents in an intragovernmental transaction container;
periodically scanning said electronic trade documents in said intragovernmental transaction container to determine if conditions exist for at least partial settlement of said transaction; and
responsive to said determination that said conditions for said at least partial settlement of said transaction exist, initiating said at least partial settlement of said transaction.

2. The method of claim 1, wherein said obtaining step comprises electronically generating said transaction from systems associated with said government agency buyer and said government agency seller.

3. The method of claim 1, wherein said obtaining step comprises creation from scratch.

4. The method of claim 1, wherein said obtaining step comprises creation from another transaction, employed as a template.

5. The method of claim 1, wherein said trade documents comprise at least an order and at least one additional document associated with said order.

6. The method of claim 5 wherein said trade documents comprise at least said order, at least one bill and at least one receipt.

7. The method of claim 6, wherein said settlement comprises complete settlement of said transaction, and wherein said conditions for settlement comprise:
posting of said order,
posting of said at least one bill, all valid line items of said order being covered by said at least one bill; and
completeness of said at least one receipt, all said valid line items of said order being covered by said at least one receipt.

8. The method of claim 7, further comprising the additional step of facilitating display of all said valid line items on all said trade documents on a single screen.

9. The method of claim 7, wherein said conditions for settlement further comprise completeness of an accrual associated with said transaction.

10. The method of claim 9, further comprising the additional steps of, subsequent to said settlement:
performing a final reconciliation on said transaction;
creating a final liquidation record in an accounting system of said government agency buyer; and
closing said intragovernmental transaction container after said final reconciliation is complete.

11. The method of claim 6, wherein said receipt has at least one line item and wherein said conditions for at least partial settlement comprise:
posting of said order;
posting of said bill, said bill being for at least one valid line item of said order, and
at least one approved bill line item, wherein said at least one line item of said order, bill and receipt match within a set of business rules.

12. The method of claim 11, further comprising the additional step of creating at least one settlement document logically linked to said intragovernmental transaction container.

13. The method of claim 11, wherein said conditions for at least partial settlement further comprise:
satisfactory checking of a tolerance between said order and said bill; and
satisfactory checking that an amount of said order is under a threshold.

14. The method of claim 11, further comprising the additional steps of:
checking a tolerance between said order and said bill;
responsive to said checking yielding an out-of-tolerance condition, placing said bill and said order in an out-of-tolerance status; and
facilitating resolution of said out-of-tolerance status via collaboration between said government agency buyer and said government agency seller.

15. The method of claim 1 further comprising the additional steps of:
checking that an amount of said order is under a threshold;
responsive to said checking yielding an over-threshold condition, placing said bill and said order in a requires approval status; and
facilitating generation of a notice that manual approval is required by said government agency buyer.

16. The method of claim 11, wherein said conditions for at least partial settlement further comprise certification by said government agency buyer.

17. The method of claim 5, wherein said order has an order number associated with it, and wherein said logical linking is based at least on said order number.

18. The method of claim 17, wherein:
said obtaining step comprises:
a first obtaining sub-step of obtaining one of:
said electronic order, with said associated order number; and
said at least one additional electronic trade document associated with said order, said at least one additional electronic trade document also having said order number associated with it;
a second obtaining sub-step of subsequently obtaining another of:
said electronic order, with said associated order number; and
said at least one additional electronic trade document associated with said order, said at least one additional electronic trade document also having said order number associated with it; and
said logical linking step comprises:
subsequent to said first obtaining sub-step, creating said intragovernmental transaction container; and
subsequent to said second obtaining sub-step, locating said intragovernmental transaction container based on said order number and linking said at least one additional electronic trade document to said electronic order.

19. The method of claim 17, further comprising the additional step of providing said intragovernmental transaction container with a unique system-generated number.

20. The method of claim 17, further comprising the additional steps of:
generating at least one additional electronic trade document associated with said order; and
logically linking said at least one additional electronic trade document with said trade documents within said intragovernmental transaction container.

21. The method of claim 20, wherein said at least one additional electronic trade document is generated in response to said determination that said conditions for said at least partial settlement of said transaction exist.

22. The method of claim 5, wherein said trade documents further comprise an advance shipping notice.

23. The method of claim 1, wherein said intragovernmental transaction container comprises a first intragovernmental transaction container, further comprising the additional step of logically linking said first intragovernmental transaction container to a second intragovernmental transaction container.

24. The method of claim 23, wherein said first and second intragovernmental transaction containers are related to a contract.

25. The method of claim 1, wherein said intragovernmental transaction container is related to a contract.

26. The method of claim 1, wherein said intragovernmental transaction container is related to a purchase order.

27. The method of claim 1, wherein said obtaining comprises:
checking said electronic documents for readability;
checking said electronic documents for correct identification of said government agency buyer and said government agency seller; and
facilitating indication of acceptance of said order by said government agency seller.

28. The method of claim 27, wherein said electronic documents comprise at least one order and at least one receipt, further comprising the additional step of performing a detailed data validation on at least one of said at least one order and said at least one receipt, said detailed data validation comprising:
checking that a total transaction amount equals a sum of line item amounts, within a rounding tolerance;
checking for population of mandatory data fields;
checking for existence of a stored record corresponding to an account code in said at least one of said at least one order and said at least one receipt; and
checking for a matching organizational relationship in business rules of said government agency buyer.

29. The method of claim 28, wherein said detailed data validation is further performed on at least one of general ledger data and line of accounting data.

30. The method of claim 27, further comprising the additional step of facilitating export of at least one of an accounting transaction, an updated order, an updated bill, and a billing record to at least one of a data processing system of said government agency buyer and a data processing system of said government agency seller.

31. The method of claim 1, further comprising the additional steps of
establishing a plurality of government agency seller rules;
establishing a plurality of government agency buyer rules; and
establishing a plurality of trading partnership rules;
wherein:
said electronic trade documents are validated, at least in part, based on said seller rules, said buyer rules, and said partnership rules; and
said conditions for said at least partial settlement of said transaction comprise, at least in part, compliance with at least some of said seller rules, said buyer rules, and said partnership rules.

32. The method of claim 31, wherein:
said plurality of government agency seller rules comprise global government agency seller rules and specific government agency seller rules;
said plurality of government agency buyer rules comprise global government agency buyer rules and specific government agency buyer rules; and
said plurality of trading partnership rules comprise global trading partnership rules and specific trading partnership rules.

33. The method of claim 1, further comprising the additional steps of:
obtaining at least one electronic grant and at least one electronic payment request associated with a grant from a government agency grantor to a government agency grantee;
logically linking said grant request to said grant based on a grantor-grantee relationship between said grantor and said grantee and a reference number of said grant;
periodically scanning said grant and said logically linked grant request to determine if conditions exist for at least generation of a partial payment record: and
responsive to determining that said conditions for said generation of said at least partial payment record exist, initiating said generation of said at least partial payment record.

34. A system comprising:
means for obtaining a plurality of validated electronic trade documents associated with a transaction between a government agency buyer and a government agency seller;
means for logically linking said electronic trade documents in an intragovernmental transaction container;
means for periodically scanning said electronic trade documents in said intragovernmental transaction container to determine if conditions exist for at least partial settlement of said transaction; and
means for, responsive to said determination that said conditions for said at least partial settlement of said transaction exist, initiating said at least partial settlement of said transaction.

35. A system comprising:
a memory; and
at least one processor, coupled to said memory, and operative to:
obtain. a plurality of validated electronic trade documents associated with a transaction between a government agency buyer and a government agency seller;
logically link said electronic trade documents in an intragovernmental transaction container;
periodically scan said electronic trade documents in said intragovernmental transaction container to determine if conditions exist for at least partial settlement of said transaction; and
responsive to said determination that said conditions for said at least partial settlement of said transaction exist, initiate said at least partial settlement of said transaction.

36. A method comprising the steps of:
obtaining at least one electronic grant and at least one electronic payment request associated with a grant from a government agency grantor to a government agency grantee;
logically linking said grant request to said grant based on a grantor-grantee relationship between said grantor and said grantee and a reference number of said grant;
periodically scanning said grant and said logically linked grant request to determine if conditions exist for at least generation of a partial payment record; and
responsive to determining that said conditions for said generation of said at least partial payment record exist, initiating said generation of said at least partial payment record.

37. A system comprising:
means for obtaining at least one electronic grant and at least one electronic payment request associated with a grant from a government agency grantor to a government agency grantee;
means for logically linking said grant request to said grant based on a grantor-grantee relationship between said grantor and said grantee and a reference number of said grant;
means for periodically scanning said grant and said logically linked grant request to determine if conditions exist for at least generation of a partial payment record; and
means for, responsive to determining that said conditions for said generation of said at least partial payment record exist, initiating said generation of said at least partial payment record.
